(19) United States
(12) Patent Application Publication
(10) Pub. No.: US 2026/0320903 A1
(43) Pub. Date: Oct. 15, 2026

(54) MULTI-MATERIAL VOLUMETRIC MODELING SYSTEMS AND METHODS

(71) Applicant: THE REGENTS OF THE UNIVERSITY OF COLORADO, A BODY CORPORATE, Denver, CO (US)

(72) Inventors: ROBERT MACCURDY, Boulder (CO); CHARLES C. WADE, Boulder, CO (US)

(21) Appl. No.: 19/485,261

(22) PCT Filed: May 13, 2024
(86) PCT No.: PCT/US2024/029121

§ 371 Date: Nov. 17, 2025

Related U.S. Application Data
(60) Provisional application No. 63/467,258, filed on May 17, 2023.

(51) Int. Cl. G06T 15/08; B29C 64/336; B29C 64/386; B33Y 50/00; G06T 17/10

(52) U.S. Cl. CPC G06T 15/08; B29C 64/336; B29C 64/386; B33Y 50/00; G06T 17/10

(57) ABSTRACT

A multi-material volumetric design compiler parses a script to generate a tree structure representing an object having multiple materials. The tree structure includes one or more leaf nodes, one or more composite nodes, and one or more multi-material nodes. Each leaf node represents a geometric primitive. Each composite node defines (i) a transformation of one sub-object connected to the composite node or (ii) a combination of two sub-objects connected to the composite node. Each multi-material node defines how each of at least two of the multiple materials is distributed over a volume of a sub-object connected to the multi-material node. The tree structure is processed to generate a multi-material volumetric representation of the object that may be outputted to a multi-material additive manufacturing device (e.g., a three-dimensional printer).

### RELATED APPLICATIONS

This application claims priority to U.S. Provisional Patent Application No. 63/467,258, filed May 17, 2023, which is incorporated herein by reference in its entirety.

### BACKGROUND

Advancements in additive manufacturing (AM) allow relatively easy, speedy, and inexpensive realization of geometries that would have been previously time-consuming, costly, or impossible to fabricate. Multi-material AM capabilities are now practical for several distinct deposition technologies. However, multi-material computer-aided design (CAD) tools have not maintained pace with AM for precise placement of multiple materials distributed throughout the full volume of a design.

### SUMMARY

One aspect of the present embodiments includes the realization that modern additive manufacturing has made significant advancements in multi-material fabrication techniques that allow for position-specific control of material deposition, but that design tools have fallen behind machine capabilities in specifying volumetric information. Traditionally, design and fabrication workflows have expressed multi-material objects as several single-material bodies. By storing only the information about the surfaces of the geometries, information about the volumetric composition of the solids is unrepresented. The intense interest in compliant mechanisms and meta-materials demands a new design method that can support architecting material distribution throughout an object.

The present embodiments solve this problem by providing a multi-material volumetric modeling system that uses a volumetric design compiler with multi-material capabilities. The system provides a scriptable suite of geometric and material design methods that enable efficient representation of objects with complex geometry and material distributions. Advantageously, the system allows functional specification of multi-material volumes that are parameterized by spatial locations, yielding complex multi-material distributions that would be impossible to describe using alternative methods.

In certain embodiments, the techniques described herein relate to a method for multi-material volumetric modeling. The method includes: processing a tree structure that represents an object having multiple materials, the tree structure including: one or more leaf nodes, each of the one or more leaf nodes representing a geometric primitive; one or more composite nodes, each composite node of the one or more composite nodes indicating (i) a transformation of one sub-object connected to said composite node or (ii) a combination of two sub-objects connected to said composite node; and one or more multi-material nodes, each multi-material node of the one or more multi-material nodes indicating how each of at least two of the multiple materials is distributed over a volume of a sub-object connected to said multi-material node.

In certain embodiments, the techniques described herein relate to a system for multi-material volumetric modeling. The system includes a processor and a memory in communication with the processor. The memory stores a tree structure that represents an object comprising multiple materials. The tree structure includes: one or more leaf nodes, each of the one or more leaf nodes representing a geometric primitive; one or more composite nodes, each composite node of the one or more composite nodes indicating (i) a transformation of one sub-object connected to said each composite node or (ii) a combination of two sub-objects connected to said each composite node; and one or more multi-material nodes, each multi-material node of the one or more multi-material nodes indicating how each of at least two of the multiple materials is distributed over a volume of a sub-object connected to said each multi-material node. The system also includes a graphics engine implemented as machine-readable instructions that are stored in the memory and, when executed by the processor, control the system to process the tree structure.

In certain embodiments, the techniques described herein relate to a method for multi-material volumetric modeling. The method includes: generating a geometric primitive for each of one or more geometry nodes of a tree structure representing an object having multiple materials; performing, for each composite node of one or more composite nodes of the tree structure, (i) a transformation of one sub-object connected to said each composite node or (ii) a combination of two sub-objects connected to said each composite node; and modifying, for each multi-material node of one or more multi-material nodes of the tree structure, a material composition of a sub-object connected to said each multi-material node.

### BRIEF DESCRIPTION OF THE FIGURES

FIG. 1 is a schematic diagram illustrating one example multi-material volumetric modeling system for development of a multi-material volumetric object from a standard 3D geometry definition, in embodiments.

FIG. 2A is a schematic illustrating one example of the tree structure of FIG. 1 corresponding to the multi-material volumetric object, in embodiments.

FIG. 2B is a schematic illustrating object representation of the tree structure of FIGS. 1 and 2A, in embodiments.

FIG. 3 is a schematic illustrating the multi-material volumetric modeling system of FIG. 1 in further example detail, in embodiments.

FIG. 4 is schematic illustrating the rendered tree of FIG. 2B with example function values during evaluation of the tree structure, in embodiments.

FIG. 5 shows a cross-sectional scan of a brain and a cross section of a 3D model of the brain to illustrate the reduction of noise through convolution, in embodiments.

FIG. 6 shows one example script illustrating the code format used to define composition and geometric primitive nodes, in embodiments.

FIG. 7 is a schematic diagram illustrating a stochastically sampled object at a resolution of seven-thousand voxels and a stochastically sampled object at a resolution of fifty-million voxels, in embodiments.

FIG. 8 shows one example algorithm for stochastically sampling a continuous vector field of material distribution into discrete voxels for printing, in embodiments.

FIG. 9A is a graph illustrating two overlapping probability density functions, in embodiments.

FIG. 9B is a schematic illustrating f-grade(x, y, z) performed over an ASTM D412 Dogbone using the probability density functions of FIG. 9A in probability mode for two materials, in embodiments.

FIG. 9C is a schematic illustrating f-grade(x, y, z) performed over an ASTM D412 Dogbone using the probability density functions of FIG. 9A in threshold mode for two materials, in embodiments.

FIG. 10A is a perspective view of one example soft-actuator, printed in three materials, generated by the multi-material volumetric modeling system of FIG. 1 using functional grading, in embodiments.

FIG. 10B shows one example script used to generate the soft-actuator of FIG. 10A, in embodiments.

FIG. 11A is a schematic illustrating an XY slice of an multi-material object defined as four squares of different materials that are combined with a Union operation to form a multi-material object, where boundaries between the different materials are not blended, in embodiments.

FIG. 11B shows a blended multi-material object resulting from performing a convolution operation of FIG. 12 over the multi-material object of FIG. 11A using a 10×10×1 blurring kernel, in embodiments.

FIG. 12 is a schematic diagram illustrating one example convolution operation implemented by the multi-material volumetric modeling system of FIG. 1, in embodiments.

FIG. 13 is a block diagram illustrating an overview of various components of the multi-material volumetric design compiler of FIGS. 1 and 3, in embodiments.

FIG. 14 is a screen shot from the multi-material volumetric design IDE of FIGS. 1 and 3 illustrating an editor in a left panel for editing the scripts and a render preview in a right panel showing output from a custom ray-tracer of a rendered object, in embodiments.

FIG. 15 is a schematic illustrating use of affine invariant representations and non-affine-invariant representations while rotations are applied to an object, in embodiments.

FIG. 16 shows renders of four composite objects chosen to demonstrate multiple tree structure configurations and real world use cases of the multi-material volumetric modeling system of FIGS. 1 and 3, in embodiments.

FIG. 17 shows the screwdriver object of FIG. 16 in further example detail, in embodiments.

FIG. 18 shows one example tree structure that generates a triply periodic gyroid infill pattern for a wing, in embodiments.

FIG. 19 shows the wing of FIG. 18 in further example detail, in embodiments.

FIG. 20 shows one example script that is parsed by multi-material volumetric design compiler to a form tree structure that is used to generate the wing of FIGS. 18 and 19, in embodiments.

FIG. 21 shows one example tree structure that generates a tetrahedron lattice unit cell with graded members, in embodiments.

FIG. 22 shows a larger lattice structure in the form of a composite tetrahedron, in embodiments.

FIG. 23 shows a table that synthesizes the current state of heterogeneous design methods and highlights the shortcomings that are addressed by multi-material volumetric modeling system of FIG. 1.

### DETAILED DESCRIPTION

The de facto standards for three-dimensional (3D) object files in additive manufacturing work-flows are the STL (Standard Triangle Language) and 3MF (3D Manufacturing Format). Both of these standards use a surface or boundary representation (b-rep) to model objects. Converting from implicit CAD formats, such as a STEP file, requires approximating the boundary surface as a triangulated mesh. The conversion from implicit to explicit representation is necessitated by slicing software that converts a model defined by STL format into printer commands (e.g., G-code format). Slicers commonly rely on extracting closed, cross-sectional polygons of 3D triangulated meshes to determine the layers of a 3D objects for AM. Consequently, engineers wishing to construct objects using multiple materials must export each component of their assembly as discrete bodies and manually assign materials in slicing software. This is known as homogeneous multi-material design. However, this workflow fundamentally limits multi-material objects to simple designs that use discrete material transitions. For designs that require several materials graded or blurred together, the existing boundary-driven workflow is ineffective. Similarly, boundary representations are incapable of expressing how material distribution changes throughout a volume. Although the 3MF format allows a single file to contain material information, 3MF is limited to expressing a body as a single material. These design approaches and representation standards cannot utilize recently emerged multi-material AM methods that deposit different materials at high resolution within a design. Particularly, existing design methods for heterogeneous objects lack the operations and exchange formats necessary to take advantage of modern voxel-level control on AM systems. Accordingly, these existing design method are limited by a trade-off between the designed object's geometric and multi-material complexities. The present embodiments address this gap with a multi-material volumetric modeling system, which may also be referred to as OpenVCAD, that provides AM designers and engineers with a framework for efficient multi-material volumetric description allowing creation of complex shapes having multiple materials.

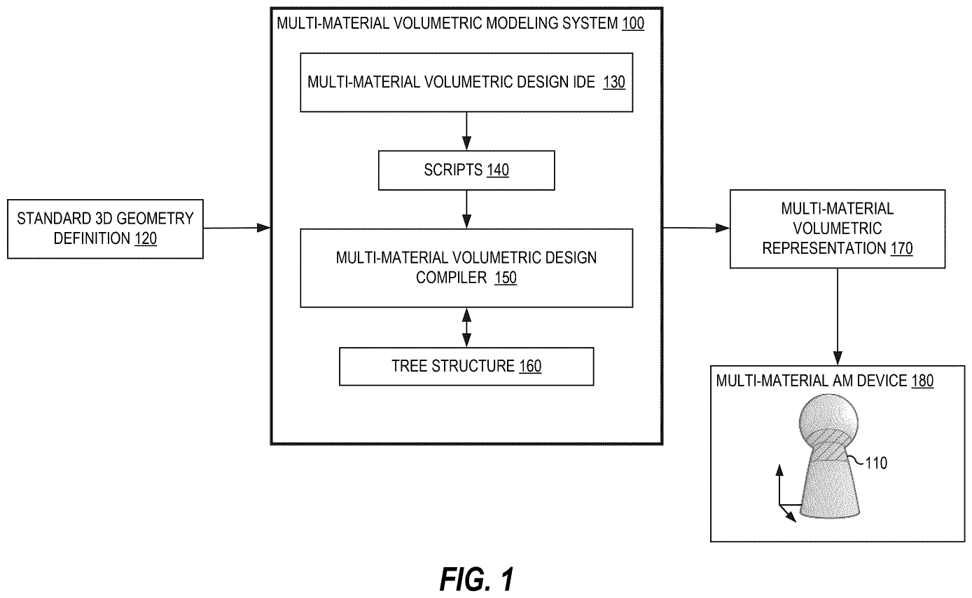

FIG. 1 is a schematic diagram illustrating one example multi-material volumetric modeling system 100 (also called OpenVCAD) for development of a multi-material volumetric object 110 from a standard 3D geometry definition 120, in embodiments. Standard 3D geometry definition 120 (also referred to herein as implicit CAD format) is generated by conventional CAD programs, for example, and defines a 3D volume using a surface or boundary representation. Multi-material volumetric modeling system 100 includes a multi-material volumetric design integrated design environment (IDE) 130 that allows a designer to interactively develop scripts 140 defining vector fields of material distributions and specific operations relevant to AM. Advantageously, multi-material volumetric design IDE 130 includes tools that allow the designer to see simulations of blended materials for multi-material volumetric object 110 based on defined scripts 140.

Multi-material volumetric modeling system 100 also includes a multi-material volumetric design compiler 150 that processes standard 3D geometry definition 120 and scripts 140 to generate a multi-material volumetric representation 170 that is output to a multi-material AM device 180 that produces multi-material volumetric object 110. Multi-material volumetric design compiler 150 generates a tree structure 160 corresponding to multi-material volumetric object 110 to facilitate generation of multi-material volumetric representation 170.

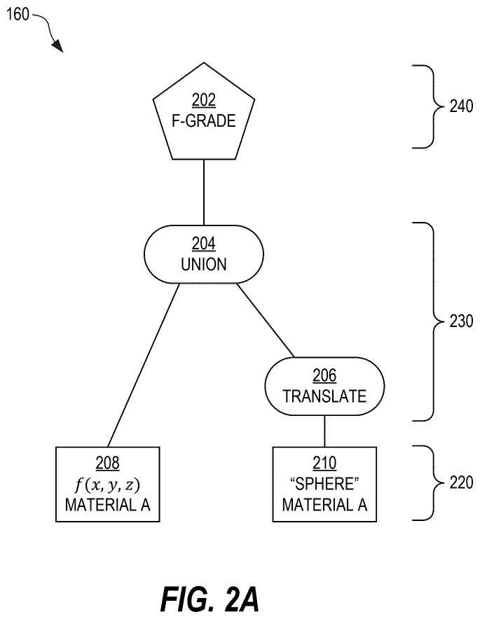

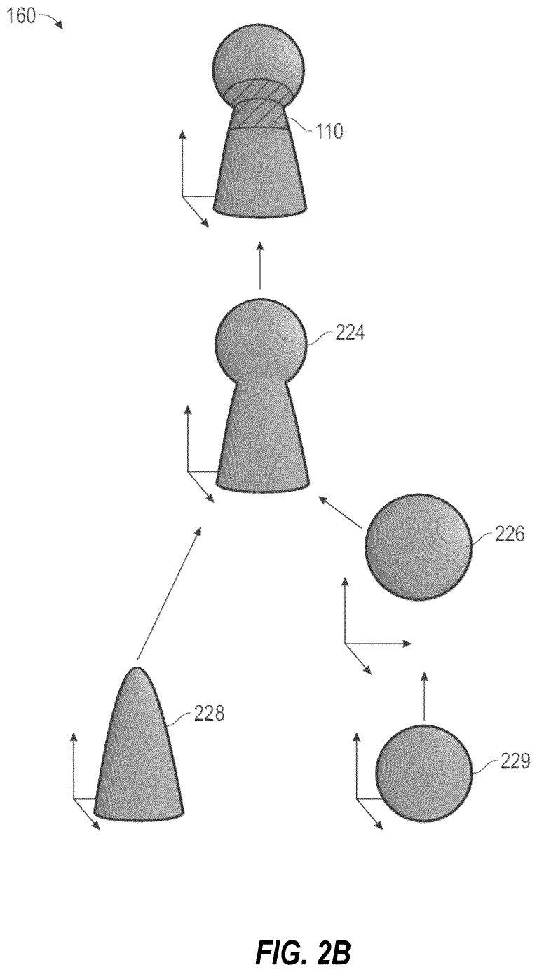

FIG. 2A is a schematic illustrating one example of tree structure 160 of FIG. 1 corresponding to multi-material volumetric object 110, in embodiments. FIG. 2B is a schematic illustrating object representation of tree structure 160 of FIGS. 1 and 2A, in embodiments. FIGS. 1, 2A, and 2B are best viewed together with the following description.

The tree structure 160 has three classes of nodes: geometry nodes 220 such as leaf nodes 208 and 210 that define geometric primitives, composite nodes 230 such as composite node 204 and composite node 206 that identify transformations and combinations (e.g., also referred to as non-leaf nodes, or branch nodes), and multi-material nodes 240, such as internal node 202, that define multi-material operations. In the representation of FIG. 2A, each geometry node 220 is shown as a rectangle, each composite node 230 is shown as a racetrack, and multi-material node 240 is shown as a pentagon. More details about these classes of nodes are presented below.

Unlike binary trees used for constructive solid geometry (CSG) techniques, the nodes of tree structure 160 may store additional information about certain materials used to model multi-material volumetric object 110, including what these multiple materials are and how the materials are distributed throughout the object. For example, geometry nodes 220 (e.g., leaf nodes 208 and 210) may indicate a CSG primitive that represents a commonly-used irreducible 3D geometric shape (e.g., cuboid, cylinder, sphere, cone, pyramid, etc.). Alternatively, the geometric primitive may be determined by an implicit function stored in geometry nodes 220, also called an implicit geometric primitive. In any case, geometry nodes 220 may further store an identifier indicating a material of which the geometric primitive is composed. The material may be, for example, one commonly used for 3D printers.

In the example of FIGS. 2A and 2B, the tree structure 160 includes leaf node 210 defining a CSG primitive “sphere.” This primitive is represented visually in FIG. 2B by a sphere 229. Sphere 229 is composed of a material type “A”, as indicated by leaf node 210. Leaf node 208 defines an implicit function ƒ(x, y, z) as the geometric primitive. In the example of FIGS. 2A and 2B, the function ƒ(x, y, z) is the closed-form expression for a paraboloid, which is represented visually in FIG. 2B as a paraboloid 228. Paraboloid 228 is made of a material type “A”, as indicated by leaf node 208. Tree structure 160 may contain additional or alternative geometry nodes 220 than shown in FIGS. 2A and 2B without departing from the scope hereof.

Tree structure 160 may store additional types of geometry nodes 220 than shown in FIGS. 2A and 2B. For example, the geometric primitive defined by geometry node 220 may be an array of voxels imported from an external geometry (e.g., bitmap stacks) or calculated from an external geometry (e.g., calculated from a triangulated mesh defined within standard 3D geometry definition 120). In either case, each voxel may store a material type associated with it. Alternatively, all of the voxels in the array may be collectively assigned one material type.

Each composite node 230 (e.g., composite node 204 and composite node 206) of tree structure 160 indicates (i) a transformation to be performed on one sub-object of tree structure 160 or (ii) a combination to be performed on two sub-objects of tree structure 160. In tree structure 160, a sub-object of a node is the object represented by a child of the node. Composite node 230 for a transformation (e.g., composite node 206) has one sub-object (e.g., one child), which represents the geometry to be transformed. Examples of transformations include, but are not limited to, translation, rotation, and scaling. Composite node 230 performing a combination (e.g., composite node 204) has two sub-objects (i.e., two children) representing the two geometries to be combined. Examples of combinations include, but are not limited to, union, difference, and intersection. Note that a combination may be performed on more than two sub-objects; however, such a combination may alternatively be expressed as several combinations of two sub-objects.

In the example of FIGS. 2A and 2B, composite node 206 translates the sphere of leaf node 210, as indicated by the translated sphere 226 in FIG. 2B. Composite node 204 that generates a union of the translated sphere represented by the composite node 206 and the paraboloid represented by leaf node 208. This union is represented in FIG. 2B by object 224. Tree structure 160 may contain additional or alternative composite nodes (translation, combination, or both) than shown in FIG. 2A without departing from the scope hereof.

There are several ways in which a composite node implementing a union may utilize the material information of the two sub-objects. For example, a hierarchy of materials may be defined. Where the union encompasses material of both sub-objects, the hierarchy may be accessed to determine which material is selected for the union. Composite nodes of the present embodiments may utilize other or additional techniques for incorporating the material information of the sub-objects without departing from the scope hereof.

Each multi-material node of tree structure 160 indicates a multi-material operation to be performed on the sub-object connected thereto. Herein, an operation is “multi-material” when it changes the physical composition of the sub-object. Thus, a multi-material node does not change the geometric of the sub-object. Similar to a composite node implementing translation, a multi-material node only operates on one child. However, the multi-material node may be configured with additional information that defines how the physical composition of the sub-object is to change. Examples of such information include, but are not limited to, identifying which one or more regions (e.g., as defined by a 3D spatial extent) of the sub-object are to be modified, which materials are involved in the operation, and one or more formulas for determining when a material should be changed.

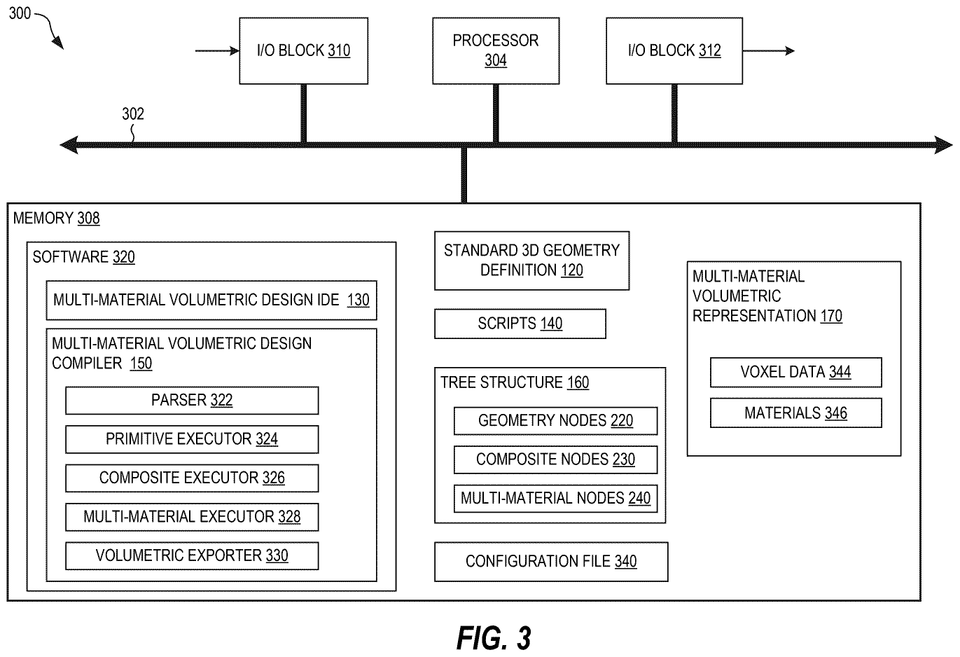

FIG. 3 is a schematic illustrating multi-material volumetric modeling system 100 of FIG. 1 in further example detail, in embodiments. Multi-material volumetric modeling system 100 is implemented by a computer 300 that includes a memory 308 that communicates with a processor 304 over a system bus 302. Computer 300 also includes an input/output (I/O) block 310 that communicates with a peripheral device (e.g., multi-material AM device 180, a memory card, etc.) or external computer (e.g., via a network) to receive standard 3D geometry definition 120 and optionally script 140. Computer 300 also includes an I/O block 312 for communicating with multi-material AM device 180 (e.g., a 3D printer). The I/O blocks 310 and 312 are also connected to the system bus 302, and therefore can communicate with the processor 304 and memory 308.

The processor 304 may be any type of circuit capable of performing logic, control, and input/output operations. For example, the processor 304 may include one or more of a microprocessor with one or more central processing unit (CPU) cores, a graphics processing unit (GPU), a digital signal processor (DSP), a field-programmable gate array (FPGA), a system-on-chip (SoC), and a microcontroller unit (MCU). The processor 304 may also include a memory controller, bus controller, one or more co-processors, and/or other components that manage data flow between the processor 304 and other components communicably coupled to the system bus 302. The processor 304 may be implemented as a single integrated circuit (IC), or as a plurality of ICs. In some embodiments, one or more of the processor 304, memory 308, I/O block 310, and I/O block 312 are implemented as a single IC. The processor 304 may use a complex instruction set computing (CISC) architecture, or a reduced instruction set computing (RISC) architecture. Memory 308 may be implemented using volatile memory (e.g., DRAM, SRAM, etc.), non-volatile memory (e.g., flash memory, NVRAM, FRAM, MRAM, EEPROM, EPROM, etc.), secondary (e.g., solid-state drive or hard disk drive), or any combination thereof.

Memory 308 stores software 320 that includes machine-executable instructions that, when executed by processor 304, control computer 300 to implement the functionality described herein. Software 320 includes multi-material volumetric design IDE 130 and multi-material volumetric design compiler 150. Multi-material volumetric design compiler 150 may be invoked from multi-material volumetric design IDE 130 or may be invoked in other ways such as from a command line. Multi-material volumetric design compiler 150 includes a parser 322, a primitive executor 324, a composite executor 326, a multi-material executor 328, and a volumetric exporter 330. In certain embodiments, one or more of primitive executor 324, composite executor 326, multi-material executor 328, and volumetric exporter 330 may be external to multi-material volumetric design compiler 150. Memory 308 may store additional or alternative software (e.g., operating system instructions, I/O control instructions, etc.) and data without departing from the scope hereof.

Memory 308 also stores data including tree structure 160 with geometry nodes 220, composite nodes 230, and multi-material nodes 240. Memory 308 also stores a configuration file 340, standard 3D geometry definition 120 (when provided, scripts 140), and multi-material volumetric representation 170. However, memory 308 may store alternative or additional data without departing from the scope hereof.

Each of the I/O blocks 310 and 312 is configured for computer 300 to communicate with one or more peripherals. For example, the I/O block 310 may receive the script 140 as entered, for example, from a keyboard. I/O block 310 may also receive standard 3D geometry definition 120 and script 140 (e.g., as files) when they are prepared on an external computer for example. I/O block 312 may drive a display and output multi-material volumetric representation 170, which includes voxel data 344 and materials 346, to multi-material AM device 180 (e.g., a 3D printer) to manufacture multi-material volumetric object 110 represented by tree structure 160. Each of the blocks 310 and 312 may represent one or more of a serial communication interface (e.g., RS-232, RS-422, RS-485, etc.), a parallel communication interface (e.g., GPIB, PCI, SCSI, etc.), a synchronous serial communication interface (e.g., I2C, SPI, SSC, etc.), a universal serial bus (USB) interface, a multi-media card interface (e.g., SD card, Compact Flash, etc.), a wired network interface (e.g., Ethernet, Infiniband, Fibre Channel, etc.), a wireless network interface (e.g., Wi-Fi, Bluetooth, BLE, ZigBee, ANT, etc.), a cellular network interface (e.g., 3G, 4G, 5G, LTE), an optical network interface (e.g., SONET, SDH, IrDA, etc.), and a fieldbus interface. Computer 300 may include additional I/O functionality, as needed, for communicating with additional peripherals.

Multi-material volumetric design compiler 150 uses parser 322 to parses scripts 140 and processes standard 3D geometry definition 120, when provided, to generate tree structure 160. Multi-material volumetric design compiler 150 then uses volumetric exporter 330 to generate multi-material volumetric representation 170, where volumetric exporter 330 invokes each of primitive executor 324, composite executor 326, and multi-material executor 328, to process tree structure 160 based on parameters of multi-material AM device 180 for example. Multi-material volumetric representation 170 includes voxel data 344 and associated materials 346 corresponding to multi-material AM device 180.

Volumetric exporter 330 assigns materials 346 to each voxel (e.g., using 3D coordinates (x, y, z)) of voxel data 344 based on tree structure 160. Tree structure 160 and geometry nodes 220, composite nodes 230, and multi-material nodes 240 defined therein, defines materials 346 to assign to voxel data 344 for each 3D coordinate (x, y, z). Voxel data 344 defines a plurality of voxels lying within a continuous three-dimensional space. In certain embodiments, the determined material is stored with each voxel as part of the voxel data 344. In other embodiments, the determined material is defined in materials 346. For example, volumetric exporter 330 iteratively calls, as needed, primitive executor 324, composite executor 326, and multi-material executor 328 to generate voxel data 344 and materials 346 such that multi-material volumetric representation 170, when output to multi-material AM device 180, instructs multi-material AM device 180 to manufacture multi-material volumetric object 110. Primitive executor 324, composite executor 326, and multi-material executor 328 are functions that are called, as needed, by volumetric exporter 330 to process tree structure 160.

In one example of operation, multi-material volumetric design compiler 150 invokes parser 322 to process scripts 140 (and optionally standard 3D geometry definition 120) to generate tree structure 160, and then invokes volumetric exporter 330 to generate voxel data 344 and/or materials 346 for multi-material volumetric representation 170. When one of the geometry nodes 220 is encountered, primitive executor 324 processes that geometry node to generate the geometric primitive specified therein. When one of the composite nodes 230 is encountered, the composite executor 326 processes that composite node to implement the transformation or combination specified therein. When one of the multi-material nodes 240 is encountered, the multi-material executor processes that multi-material node to implement the multi-material operation specified therein.

While FIG. 3 shows computer 300 with one system bus 302, computer 300 may be alternatively implemented with a different type of architecture. For example, software 320 may be implemented as firmware stored in a different memory than memory 308, thereby implementing a Harvard architecture. In this case, software 320 and its associated data may be communicated to/from processor 304 using separate buses. Alternatively, processor 304 may include one or more layers of cache so that computer 300 implements a modified Harvard architecture using only the one system bus 302. In some embodiments, software 320 is stored as one or more applications in a secondary storage (e.g., a hard drive). The application is loaded into memory 308 either as part of the power-on sequence of computer 300 or by explicit execution of the application (e.g., multi-material volumetric design IDE 130 and/or multi-material volumetric design compiler 150). In this case, the application and its data share the same memory space, implementing a von Neumann architecture.

The following description provides multiple examples of functionality provided through use of scripts 140 and corresponding multi-material nodes 240. One example multi-material node 240 implements probability-based functional grading that is used to create smooth transitions between regions of different materials. Another example multi-material node 240 implements threshold-based functional grading that is used to specify sharp transitions between regions of different materials. Another example multi-material node 240 implements a convolution that is used to transform a sharp transition between different materials into a smoother or blended transition.

Multi-material nodes 240 may implement other multi-material operations without departing from the scope hereof. Advantageously, since multi-material volumetric modeling system 100 is based on scripts 140, the designer may implement multi-material node 240 with any type of multi-material operation. That is, the use of scripts 140 provides a user of multi-material volumetric modeling system 100 with significant flexibility of how multi-material volumetric object 110 is defined.

In the example of FIGS. 2A and 2B, tree structure 160 includes internal node 202 that implements a functional gradient on the sub-object represented by composite node 204. As shown in FIG. 2B, multi-material volumetric object 110 is obtained by performing a functional gradient on object 224. Thus, while the object 224 is made of only material A, multi-material volumetric object 110 is made of at least two materials, where the second (or more) material is defined by internal node 202.

Tree structure 160 may contain additional or alternative multi-material nodes 240 than shown in FIG. 2A without departing from the scope hereof. Furthermore, it is not necessary that the root node of tree structure 160 be a multi-material node; it may be a composite mode instead.

### Volumetric Multi-Material Design for AM

To leverage advances in multi-material additive manufacturing, designers need access to easy and intuitive design methods. Toward this goal, multi-material volumetric modeling system 100 is an implicit geometry scripting language and compiler for volumetric representations. Multi-material volumetric modeling system 100 includes multi-material volumetric design IDE 130 that provides a scripting interface to enable a hybrid design approach, combining f-rep geometry (e.g., standard 3D geometry definition 120) with a user-definable vector field of material distributions and specific operations relevant to AM. The script language includes geometric primitives and combinatory operations to describe complex 3D shapes made of multiple complex material distributions. Designers may use familiar scripting components, such as keywords, functions, and braces to express a hierarchy of primitives and combinatory operations. Leveraging the advantages provided by a geometric compiler paradigm, the scriptable approach of multi-material volumetric modeling system 100 allows for parametric designs that may be configured for application-specific needs. Furthermore, many of the application domains of multi-material volumetric modeling system 100 require the modularity provided by a scriptable geometry approach. For example, with a scripted approach, forward and reverse integration of parameters for optimization of material distribution and geometric features is possible. This is achieved by first assigning variables to parameterize geometry and material distribution in the design script. A method to compile VCAD designs into a volumetric finite element analysis mesh for finite element analysis (FEA) is discussed later. The FEA mesh may then be simulated for multiple desired mechanical or material behaviors and fitness functions derived. The fitness functions may then be used in a heuristic optimization method to determine new variables for future design generations.

### Tree Definition

Scripts 140 are parsed into tree structure 160 that acts as a blueprint for multi-material volumetric object 110. Geometry nodes 220 express geometric features and optionally material distribution. Geometry nodes 220 are specified with various keywords within the scripting language. Parent nodes may be either composite nodes 230 that define transformations and/or combinations of geometric primitives, or multi-material nodes 240 that define material distributions. In the scripting language, parent-child relationships are denoted with functions and braces. Tree structure 160 enables efficient look-up for fast sampling of the composite design in R³. As a result, all nodes in tree structure 160 have the form Node(x, y, z), where the geometry and material (or absence of) at any point in space may be accessed using Cartesian coordinates. In the example of FIGS. 2A and 2B, geometry is defined by geometry nodes 220 (e.g., leaf nodes 208 and 210) using a f-rep( ) node to define paraboloid 228 and a sphere( ) node to define sphere 229 in this example. Composite node 206 is then used at the parent level to translate the sphere upwards. Composite node 204 (a union( ) node) is applied to combine the discrete geometries into object 224. Finally, internal node 202 applies a functional gradient across object 224 to blend two materials to form multi-material volumetric object 110.

Geometry and material distribution are sampled independently in multi-material volumetric modeling system 100. Geometry is sampled in the form g(x, y, z), where negative values correspond to points inside the surface, positive values correspond to points outside of the surface, and the value 0 corresponds to points on the surface. Similarly, let m: R³→Rⁿ be a function representing material distribution. For any point (x, y, z)∈R³, the function m(x, y, z) returns a vector in Rⁿ representing the volume fractions at the point (x, y, z). Implicit in this definition is that everywhere m(x, y, z) is defined, g(x, y, z) must also be defined. Evaluation of tree structure 160 starts at the root node (e.g., internal node 202) and in-order traversal is performed recursively on children.

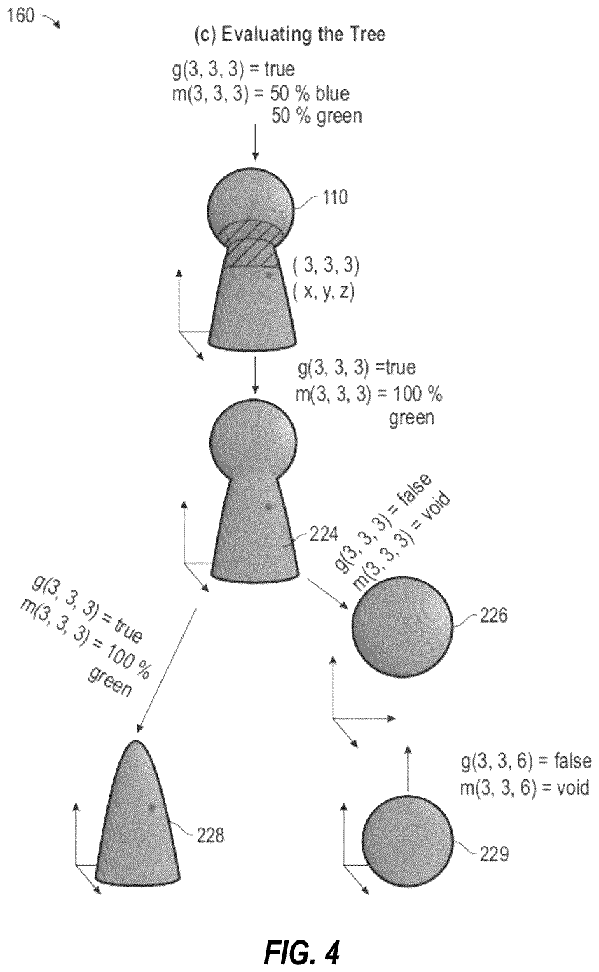

FIG. 4 is schematic illustrating the rendered tree of FIG. 2B with example function values during evaluation of tree structure 160, in embodiments. FIGS. 2A, 2B, and 4 and Table 1 detail how various nodes affect the evaluation as the traversal is performed. Starting at the root and evaluating m(x, y, z), the F-grade node (e.g., internal node 202) replaces the child material distribution with a new distribution by evaluating functions supplied as parameters when the node was created. F-grade does not affect geometry, so the result of calling g(x, y, z) on the child is returned. Moving to the second level down, at composite node 204, a union is performed between child a and child b. The Union node (composite node 204) is defined with two child nodes. Initially, we calculate α=g_{left}(x, y, z) and β=g_{right}(x, y, z).

TABLE 1
Summary of how nodes in multi-material volumetric modeling system
100 affect the evaluation of the geometry g(x, y, z) and material
m(x, y, z) spatial functions. These nodes are not an exhaustive
list of the nodes available in multi-material volumetric modeling
system 100, but are representative of the set of nodes that perform
functional material representation, “boolean” operations,
affine transforms, functional geometry representation, and primitive
geometries, respectively from top to bottom in the table.

| | Node | | |
|---|---|---|---|
| Node | Parameters | g(x, y, z) | m(x, y, z) |
| F-grade | m_{new}(x, y, z) | g_child(x, y, z) | m_{new}(x, y, z) |
| Union | NA | min(g_{child}_{_{—}}ₐ(x, y, z), | normalized sum |
| | | g_{child}_{_{—}}_{b}(x, y, z)) | of m_{child}_{_{—}}ₐ |
| | | | and m_{child}_{_{—}}_{b} |
| | | | OR specified |
| | | | m_{child x} |
| Translate | (Δₓ, Δ_{y}, Δ_{z}) | g_{child}(x − Δₓ, | m_{child}(x − Δₓ, |
| | | y − Δ_{y}, | y − Δ_{y}, |
| | | z − Δ_{z}) | z − Δ_{z}) |
| F-rep | f (x, y, z), | f (x, y, z) | 100% |
| | specified | | specified |
| | material | | material |
| Sphere | Radius, | x² + y² + z² − R² ≤ 0 | 100% |
| | specified | | specified |
| | material | | material |

Following this, the union of these two values is determined by computing min(α, β), which selects the minimum of the two computed values. m(x, y, z) for the union node first performs component-wise addition between the volume-fraction vectors returned by calling m_{child_x} on each child. The resultant vector is then normalized to ensure components sum to one (alternatively, there is an option to simply return the m(x, y, z) from one of the children). Following the left hand sub-tree rooted at the union node, an f-rep leaf node (e.g., leaf nodes 208) is reached. This node evaluates a user-supplied signed distance function, ƒ(x, y, z), for g(x, y, z). The f-rep node always returns 100% concentration of a user-specified material for m(x, y, z). The right hand sub-tree rooted at the union leads to a translate node (e.g., composite node 206). When defining a translate node, the designer species translation values, (Δₓ, Δ_{y}, Δ_{z}). These values are subtracted from the sampled point (x, y, z) to yield new transformed coordinate space. Finally, following the child of the translate node, we reach a sphere leaf node (e.g., leaf node 210). The sphere node is a CSG primitive that evaluates the sphere equation x²+y²+z²−R²≤0 for g(x, y, z). Identically to the f-rep node, the sphere node always returns 100% concentration of a default material for m(x, y, z).

### Leaf Nodes: Geometric Primitives

Multi-material volumetric modeling system 100 supports two types of geometry nodes 220 for defining geometric features: (1) CSG primitives and (2) implicit geometry in R³. CSG primitives include cuboids, cylinders and spheres, using cube( ), cylinder( ), and sphere( ) syntax respectively. Alternatively, designers may express implicit geometry using closed-form expressions in the form ƒ(x, y, z). When R³ is sampled, a point is considered inside a 3D shape if the evaluation of ƒ(x, y, z) returns a number less than zero. Likewise, the point lies on the surface of the object if ƒ(x, y, z) is exactly zero. Designers supply the implicit expression as a parameter of the f-rep node when writing scripts 140. Geometry nodes 220 (e.g., f rep( ) nodes) are processed by primitive executor 324 that uses the Exprtk C++ library to parse the mathematical expressions into a real value. This expression parser is capable of parsing many common math functions such as exp, sin, pow and sqrt, in addition to more complicated Boolean logic. When evaluating an expression, multi-material volumetric modeling system 100 provides the sampled point in cartesian, cylindrical, and spherical coordinates. As an example of an implicit geometry node, Equation 1 shows the expression for a sphere of radius R.

x²+y²+z²−R²≤0 (1)

### Leaf Nodes: External Geometry

In some applications, it may be advantageous to use traditional CAD tools to express geometry (e.g., in standard 3D geometry definition 120) and use multi-material volumetric modeling system 100 to define material distribution. Consequently, multi-material volumetric modeling system 100 allows for the import of geometry through two auxiliary nodes: (1) triangulated meshes and (2) voxel data. The mesh( ) node allows the designer to import a triangulated mesh as a leaf node in tree structure 160. Before the node is sampled in R³, multi-material volumetric design IDE 130 or multi-material volumetric design compiler 150 preprocesses the triangulated mesh into a signed distance field stored within a sparse voxel grid using a known method.

Similar to the mesh( ) node, the voxel( ) node provides an interface for designers to import existing voxel data into tree structure 160. For the voxel( ) node, multi-material volumetric design IDE 130 or multi-material volumetric design compiler 150 preprocesses bitmap stacks into a 3D sparse voxel grid that allows for constant time access of discrete material values in R³. As an additional step to preprocessing for the voxel( ) node, multi-material volumetric design IDE 130 or multi-material volumetric design compiler 150 remaps asymmetric input data to uniform voxels. This is a critical component because many volumetric inputs, such as medical imagery, sample using asymmetric resolutions and need to be remapped to the voxel size of multi-material AM device 180 (e.g., the target printer). The voxel input workflow is useful for volumetric 3D printing of presurgical planning models. In this application space, medical imaging data is processed into stacks of bitmap files that represent a discrete voxel space. The bitmaps are often printed with materials that emulate the color of the anatomic object they represent. Multi-material volumetric modeling system 100 includes a multi-material design toolkit that is well suited to perform 3D processing on these medical models to reduce noise, highlight features, and modify material distribution.

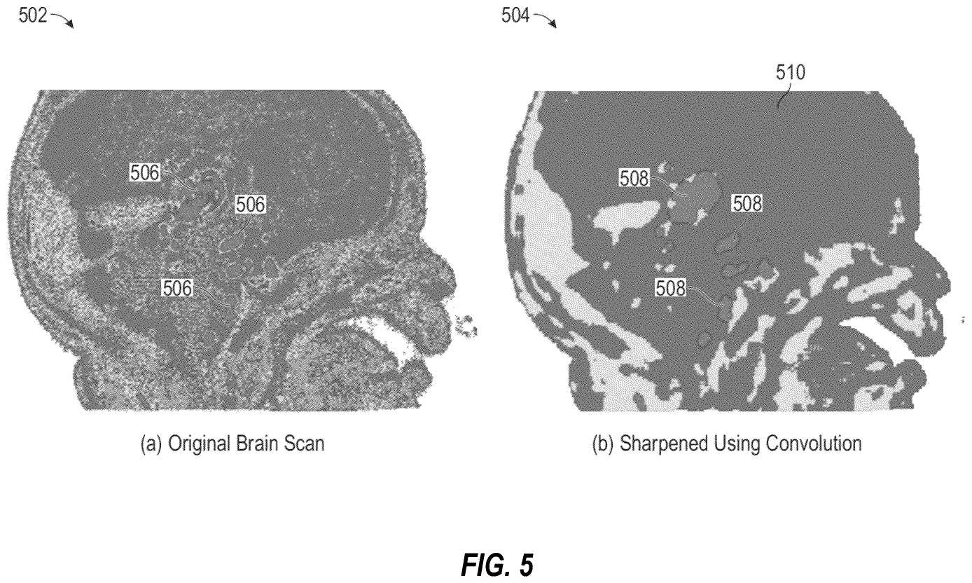

FIG. 5 shows cross-sectional scan 502 of a brain and a cross section of a 3D model 504 of the brain to illustrate the reduction of noise through convolution, in embodiments. When printed with transparent materials, the object provides a practitioner with a handheld 3D visualization to aid in presurgical planning for example. However, cross-sectional scan 502 contains noise that obscures the view of interior target regions 506. 3D model 504 is generated by multi-material volumetric modeling system 100 applying a discrete convolution node (discussed below) to sharpen operation in R³ to improve the transparency of non-important areas 510 by reducing noise in cross-sectional scan 502 such that interior target regions 508 are visible through non-important areas 510. Furthermore, multi-material volumetric modeling system 100 may be used to map discrete and continuous regions to meta-materials that simulate the mechanical behavior of specific tissue.

### Composite Nodes

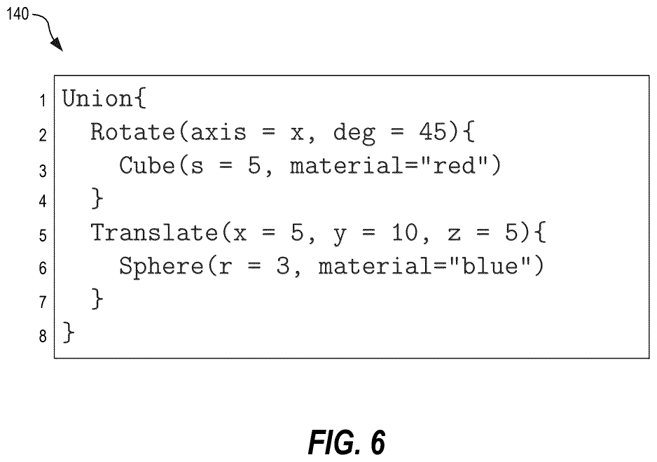

Composite nodes 230 are critical for describing complex shapes by defining transformations and combinations of both geometric primitives and any valid subtree of tree structure 160. Examples of transformations include translate( ), rotate( ), and scale( ). Example of combinations refer to the boolean operations of negate( ), union( ), difference( ), and intersection( ). In one example, when two nodes with different materials are combined through a union operation, their intersecting material distributions are summed and then normalized to yield a blended region. Other material transitions may be defined with multi-material nodes, discussed in further detail below. FIG. 6 shows one example script 140 illustrating the code format used to define composition and geometric primitive nodes, in embodiments.

### Multi-Material Nodes: Functional Grading

Multi-material volumetric modeling system 100 includes a unique ability with multi-material nodes 240 to express heterogeneous volumes. One example of multi-material node 240 is a functional grading (FG) node. FG nodes enable smooth material interfaces and precise control over the material properties of multi-material volumetric object 110. FG nodes employ a user-defined 3D vector field to assign material values to existing geometry. The vector field is n-dimensional, where each component represents the volume fraction of a particular material. To create the material distribution, the designer first defines multiple scalar field equations in R³ of the form ƒ grade(x, y, z). These expressions are independent, but spatially overlapping, volume fraction functions that each describe the concentration of a single associated material for all points in a 3D region of interest. Since each scalar field is overlapping, they may be combined component-wise into a single vector field. The volume fraction functions are normalized so that they sum to one for all points. Normalization is necessary to ensure that the evaluation of each volume fraction function represents the overall concentration the corresponding material is present at the specific point in space.

Although a continuous vector field distribution of materials provides a compact method for expressing heterogeneous objects, it is not directly compatible when multi-material AM device 180 requires voxels as input. Stochastic sampling is needed to convert from a continuous distribution of materials to discrete voxels. Stochastic sampling, sometimes referred to as stochastic dithering, is a common procedure used in both 2D and 3D inkjet printing to create the illusion of more colors than are present in material channels of the printer.

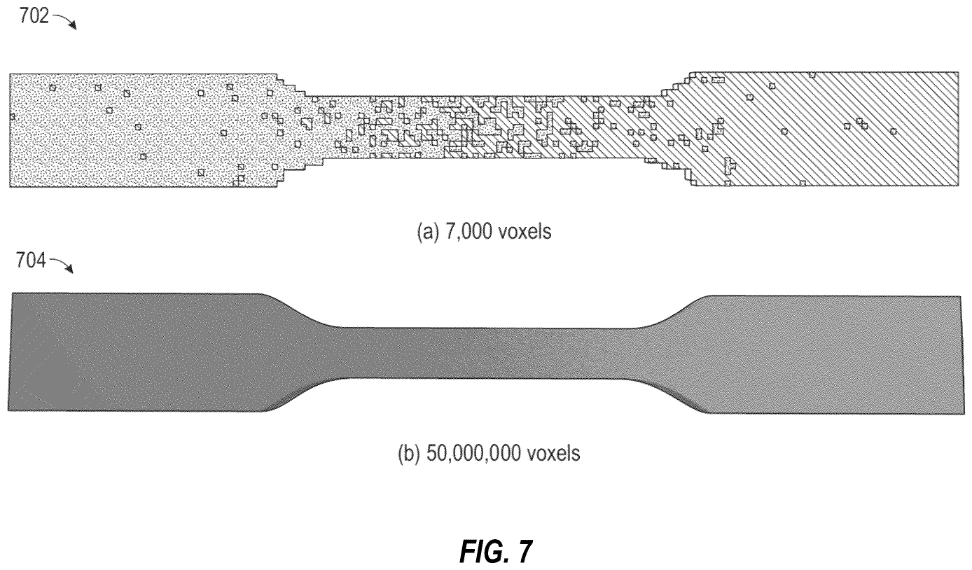

FIG. 7 is a schematic diagram illustrating a stochastically sampled object 702 at a resolution of seven-thousand voxels and a stochastically sampled object 704 at a resolution of fifty-million voxels, in embodiments. Each object 702 and 704 was graded across the x-axis with two different materials (e.g., a blue and a red material) using equations 2 and 3 respectively.

$${P}_{red} = \frac{1}{1 + {e}^{x}} \qquad ( 2 )$$

$${P}_{b l u e} = - \frac{1}{1 + {e}^{x}} + 1 \qquad ( 3 )$$

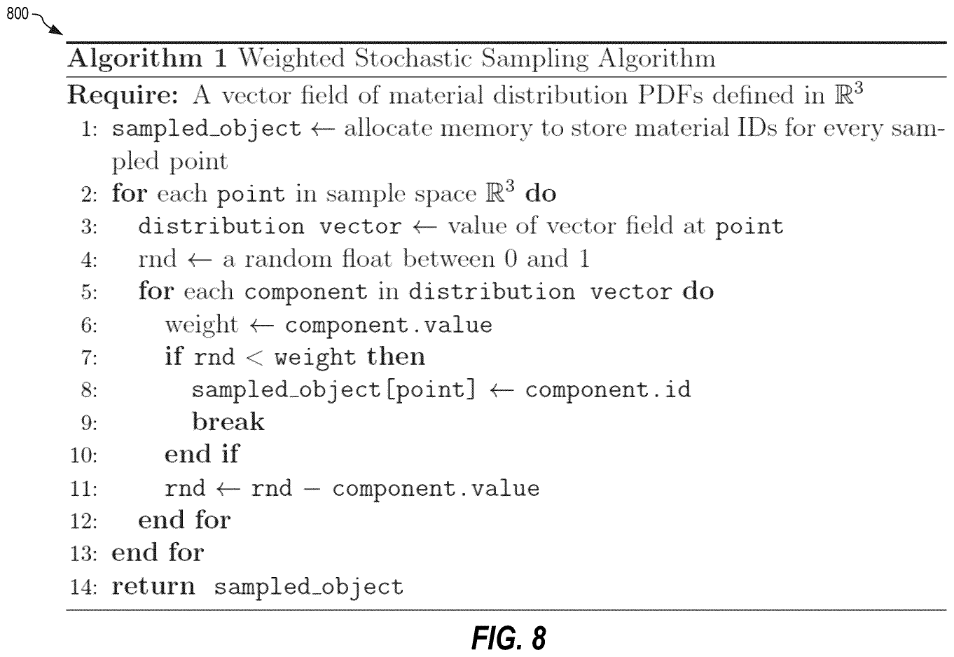

As the voxel resolution approaches the scale of an inkjet system (10⁹ voxels) the individual cell colors blend together. Multi-material volumetric modeling system 100 offers two distinct sampling modes: probability and threshold. In probability mode, the volume fraction functions are treated as Probability Density Functions (PDFs). This approach interprets a sampled point in the three-dimensional space, R³, through these PDFs. Consequently, each sampled point generates a probability vector, which indicates the likelihood of each material being present at that location. The final material assigned to a specific location (e.g., only one material occupies any one discrete location) is determined by a stochastic decision, which is weighted according to the calculated probability vector. FIG. 8 shows one example algorithm 800 for stochastically sampling a continuous vector field of material distribution into discrete voxels for printing, in embodiments. The stochasticity ensures that a distribution of materials is present when performing functional grading.

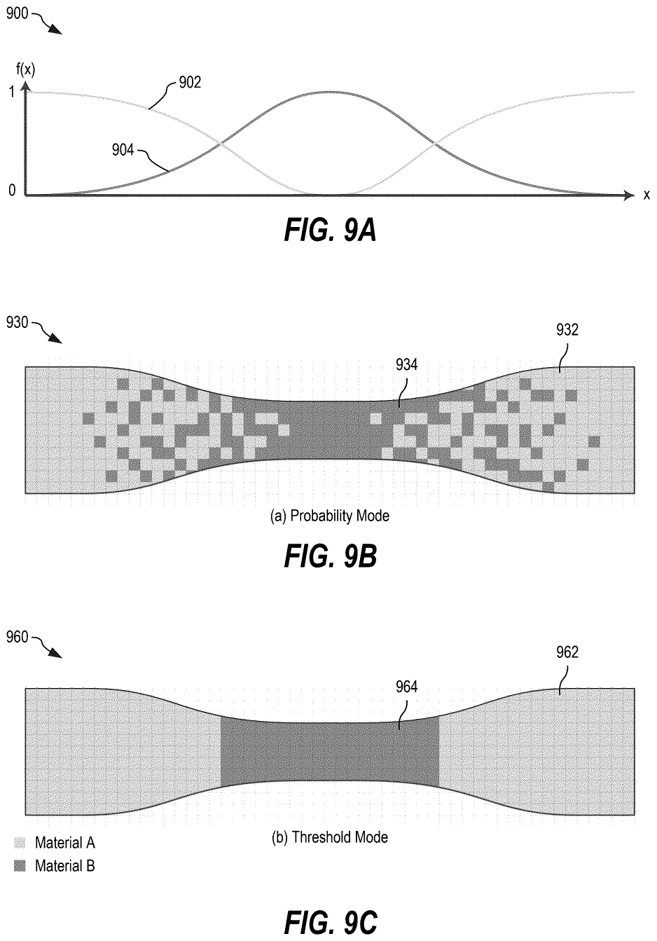

FIG. 9A is a graph 900 illustrating two overlapping probability density functions 902 and 904, in embodiments. FIG. 9B is a schematic illustrating ƒ-grade(x, y, z) performed over an ASTM D412 Dogbone 930 using probability density functions 902 and 904 of FIG. 9A in probability mode for two materials 932 and 934, respectively, in embodiments. FIG. 9C is a schematic illustrating ƒ-grade(x, y, z) performed over an ASTM D412 Dogbone 960 using probability density functions 902 and 904 of FIG. 9A in threshold mode for two materials 962 and 964, respectively, in embodiments. In this example, a tensile strength validation geometry is enhanced when material 934/964 is stronger than material 932/962 in the thinner section of Dogbone 930/960, respectively.

In particular, FIGS. 9A and 9B show that probability mode allows for the creation of smooth transitions and “digital materials” by specifying the mixture ratio of multiple materials over a region based on the probability distribution. In contrast, FIGS. 9A and 9C show that threshold mode allows for deterministic control over the material composition of a component. In threshold mode, the designer defines the same field equations as volume fraction functions; however, the weighted randomization phase is replaced by selecting the material corresponding to the highest volume fraction. From FIG. 9C it is observed that threshold mode generates sharp material transitions within geometry. While sharp material transitions may also be created using only Boolean combinations of geometric primitives, thresholding FG nodes allow for more concise design trees and shorter files.

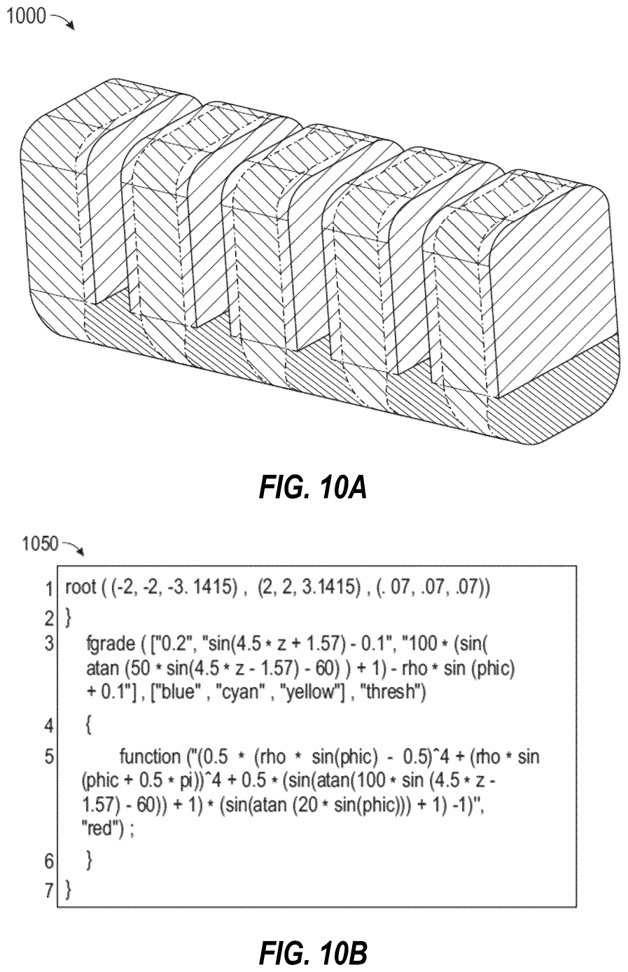

FIG. 10A is a perspective view of one example soft-actuator 1000, printed in three materials, generated by multi-material volumetric modeling system 100 of FIG. 1 using functional grading, in embodiments. Soft-actuator 1000 was created using a scalar field equation in polar coordinates with a threshold of 1 to generate the geometry, and was then functionally graded in threshold mode using three distinct scalar fields over the entire bounding box of the model. Soft-actuator 1000 was then printed using the Stratasys J750 InkJet Printer.

FIG. 10B shows one example script 1050 used to generate soft-actuator 1000 of FIG. 10A, in embodiments. Particularly, a corresponding tree structure 160 for soft-actuator 1000 uses a single implicit geometry leaf node to generate the shape of the actuator, and an FG node in threshold mode to define regions of different material. In contrast, to represent soft-actuator 1000 solely as Boolean combinations of primitives, tree structure 160 would require the union of nineteen leaf nodes, one for each discrete region of a single material.

### Multi-Material Nodes: Convolution

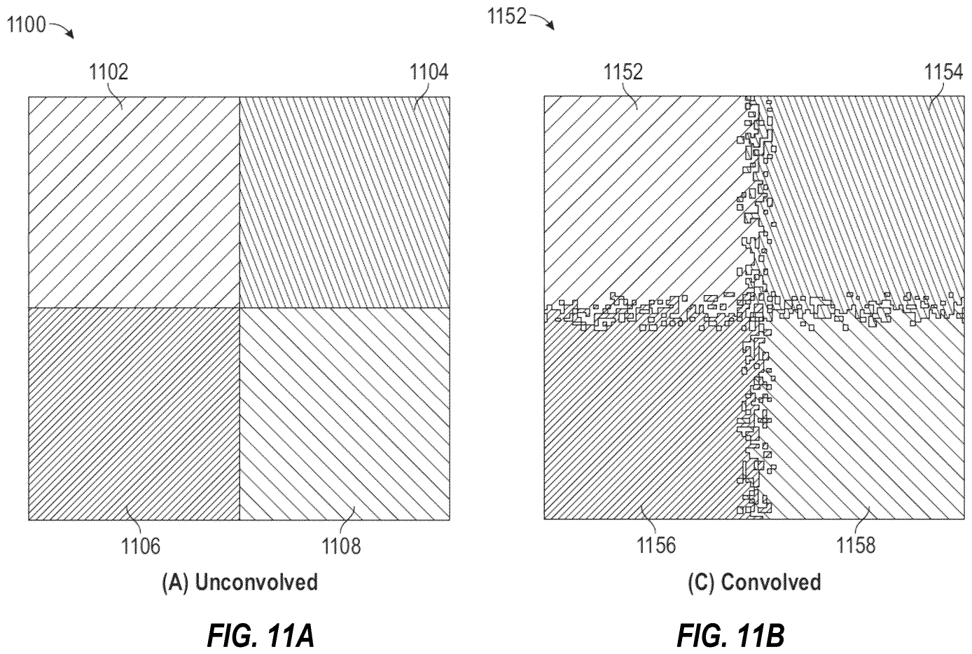

While functional grading provides a mechanism for defining material transition within geometry, it may be cumbersome for blending across multiple pre-existing material boundaries, as might occur with imported geometry (e.g., importing and using standard 3D geometry definition 120). FIG. 11A is a schematic illustrating an XY slice of an multi-material object 1100 defined as four squares 1102, 1104, 1106, and 1108 of different materials that are combined with a Union operation to form a multi-material object 1100, where boundaries between the different materials are not blended, in embodiments. Where the designer wishes for the four material regions to be blended at their boundaries to exhibit a smoother transition from one material to another, using functional grading, the designer would develop a set of complex probability density functions expressed in terms of x and y. Advantageously, multi-material volumetric modeling system 100 implements discrete convolution that provides a simpler approach to smoothing material transitions.

Convolution is a common operation in signal processing, computer vision, and machine learning used to perform many operations including blurring, sharpening, eroding, dilating and other image manipulations. The convolution operation expresses how the shape of one function is modified by another. In image processing, convolution is done with an input image and 2D kernel. Each pixel of the image is sampled and replaced with the sum of its neighbors multiplied by the kernel weights. Using a specific kernel, convolution is used to perform Gaussian blurring and sharping on an image for example.

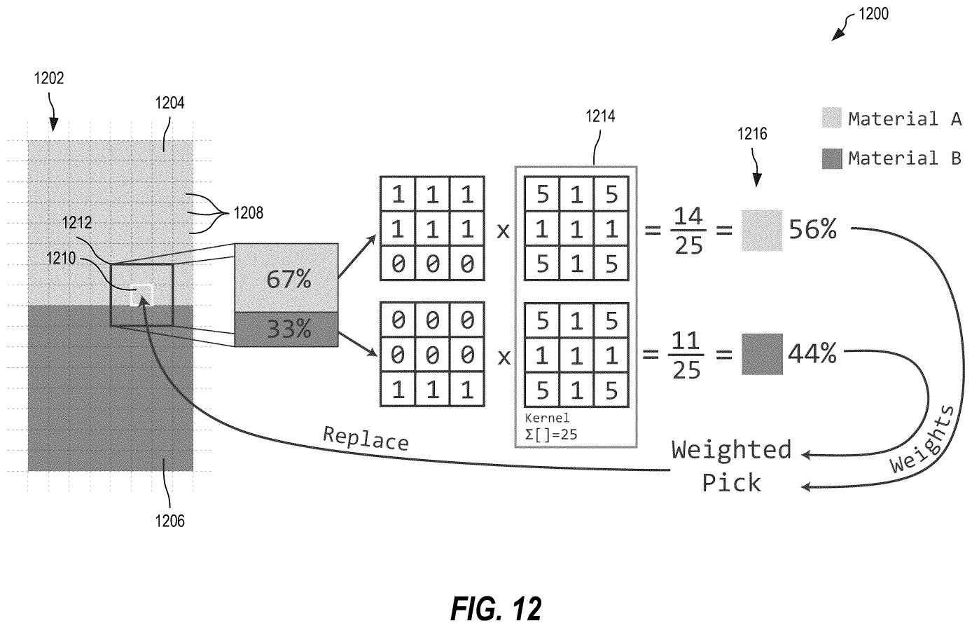

Multi-material volumetric modeling system 100 defines a node that may be used to perform discrete convolution over 3D volumetric data. FIG. 12 is a schematic diagram illustrating one example convolution operation 1200 implemented by multi-material volumetric modeling system 100 of FIG. 1, in embodiments. For clarity of illustration, one example convolution operation 1200 performs a two-dimensional convolution; however, one example convolution operation 1200 performs a three dimensional convolution to smooth the transition between materials 1204 and 1206 at the interface. In this example, an object 1202 is formed of two different materials 1204 and 1206 that are illustrated as a grid of voxels 1208. For a target voxel 1210, convolution operation 1200 first considers the distribution of materials in a kernel region 1212 around target voxel 1210. Analogous to 2D image convolution, an N by M by K 3D kernel 1214 expresses the weight that neighboring voxels have at target voxel 1210. These weights are multiplied by the corresponding material counts at kernel region 1212 to yield a modified material distribution 1216 for each material. Material distributions 1216 are then used as probabilities for a stochastic decision on what the material at target voxel 1210 should be replaced with. In the example of FIG. 12, convolution operation 1200 determines a 56% chance that materials 1204 (material A) and a 44% chance that materials 1206 (material B) will be selected. The weighted stochastic process then selects and replaces the material at target voxel 1210. The process is repeated at all sampled locations in R³ using the original material values to create the mixed boundary between materials. Accordingly, this generates a convolution-based distribution of materials. FIG. 11B shows a blended multi-material object 1150 resulting from performing convolution operation 1200 of FIG. 12 over multi-material object 1100 of FIG. 11A using a 10×10×1 blurring kernel, in embodiments. As shown in FIG. 11B, material 1152 blends with material 1154 at the interface therebetween, material 1152 blends with material 1156 at the interface therebetween, material 1154 blends with material 1158 at the interface therebetween, and material 1156 blends with material 1158 at the interface therebetween.

### Multi-Material Compiler

The representation of objects as a “tree of operations” allows efficient storage of geometric and volumetric (material assignment) information in multi-material volumetric modeling system 100. Likewise, the expressions of leaf nodes as implicit geometry maintains a high level of dimensional accuracy. To maintain high degrees of both object and material complexity, multi-material volumetric modeling system 100 allows for material distributions to be defined as operators. However, defining material distributions in operators is not a universally better approach. For instance, medical scan data directly couples material assignments to geometric regions. As such, multi-material volumetric modeling system 100 allows for material distributions to specified alongside geometry for the voxel( ) input node. Flexibility in where the material distributions are defined in the tree allows the designer to select the method that best suites the needs of their design.

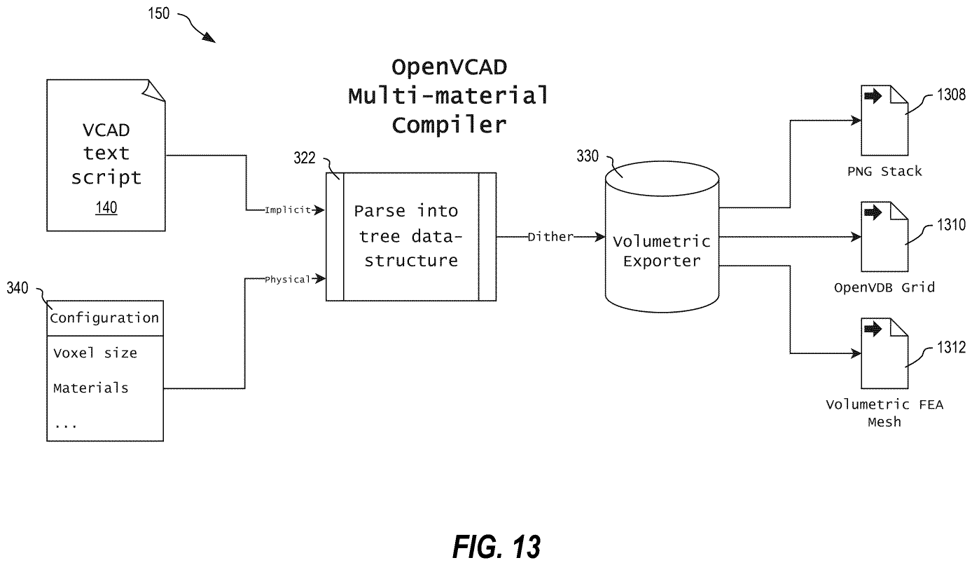

The flexibility in material specification is made possible by multi-material volumetric design compiler 150 of FIG. 1. FIG. 13 is a block diagram illustrating an overview of various components of multi-material volumetric design compiler 150 of FIGS. 1 and 3, in embodiments. Scripts 140 specify designs using the modeling language of multi-material volumetric modeling system 100. Multi-material volumetric design compiler 150 includes a parser 322 that receives scripts 140 and a configuration file 340 that defines characteristics of multi-material AM device 180, which is the specific machine used print multi-material volumetric object 110. Parser 322 translates scripts 140 into tree structure 160. Stochastic sampling is then performed based on the methods specified by nodes of tree structure 160. A user-selected volumetric exporter 330 is then used to save the design into a desired format.

AM workflows use slicing software to convert 3D objects into layer information that is commonly expressed as either g-code pathing or pixel-based bitmap stacks. Consequently, numerous slicing packages exist to convert explicit geometry files, such as Standard Triangle Language (STL) or the 3D Manufacturing Format (3MF), to a printable format. Multi-material volumetric modeling system 100 implements slicing functionality through selected volumetric exporters 330. In a current implementation, multi-material volumetric modeling system 100 includes three volumetric exporters 330 that may be selected for driving multi-material AM device 180 (e.g., a voxel-based 3D-printer), graphics & rendering, and simulation & optimization. The most common exchange format accepted by voxel-based printers is the PNG stack 1308. If a design is exported from multi-material volumetric modeling system 100 as PNG stack 1308, each image file represents a single layer-slice of multi-material volumetric object 110. Furthermore each pixel in a layer-slice contains a color mapped to specific material channel in multi-material AM device 180. The directory of PNG images may then be transferred to the printer for construction of multi-material volumetric object 110.

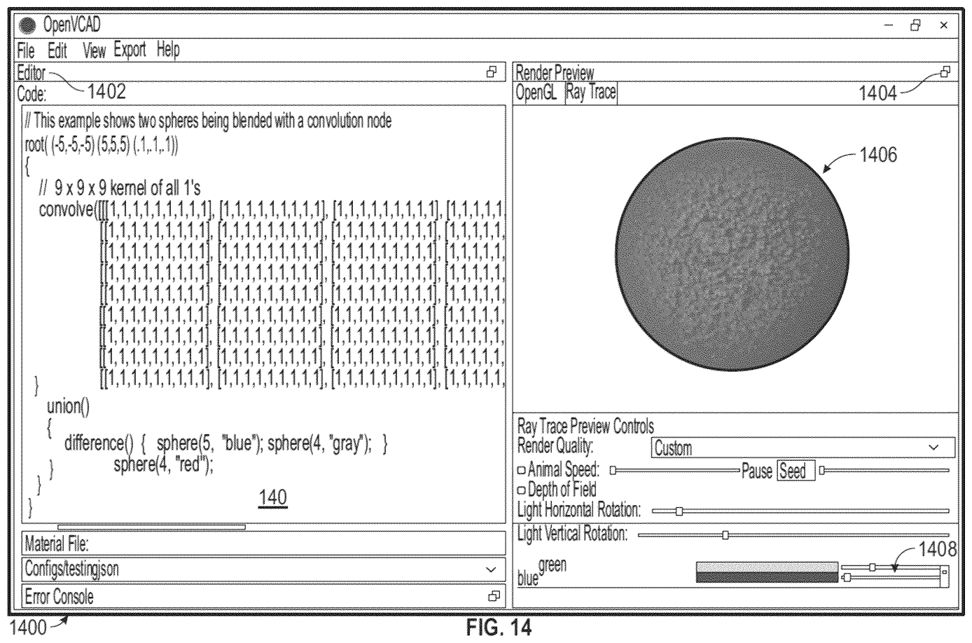

FIG. 14 is a screen shot 1400 of multi-material volumetric design IDE 130 of FIG. 1 illustrating an editor 1402 in a left panel for editing scripts 140 and a render previewer 1404 in a right panel showing a render preview 1406 from the custom ray-tracer of a rendered object that contain transparent elements, allowing the designer to visualize internal volumetric structures, in embodiments. Interactive rendering is another critical feature of multi-material volumetric modeling system 100. As such, multi-material volumetric design compiler 150 may export designs to OpenVDB/NanoVDB voxel-grids 1310. In this format, each voxel contains an integer ID that corresponds to the user-defined IDs in the material configuration supplied to the compiler. Editor 1402 of multi-material volumetric design IDE 130 allows the designer to create and edit scripts 140 in a left panel for example. Multi-material volumetric design IDE 130 provides an option to compile the design for rendering as render preview 1404 by previewer 1404 in a right panel of multi-material volumetric design IDE 130. For example, the NanoVDB volumetric exporter is used to export the design as a voxel-grid to the GPU of computer 300 where render preview 1404 implements a ray-tracer to render the design with realistic shading. Sliders 1408 along the bottom of render preview 1404 control the opacity of the materials present in the design.

Multi-material volumetric design compiler 150 may export designs as at least one volumetric FEA mesh 1312 for the simulation of designs using the Abaqus FEA package, for example. Forward integration (simulation and analysis) and inverse integration (shape and/or material optimization) is possible by using the finite element volumetric exporter 330 and input of scripts 140, respectively.

When sampling with multi-material volumetric design compiler 150, the designer specifies the range of R³ and the voxel-size they wish to use for their design. It is common for voxel-based 3D-printers to use asymmetric voxels. As a result, multi-material volumetric modeling system 100 allows designers to specify (e.g., in configuration file 340) each XYZ dimension of the voxels independently used to discretize the design. This customization allows for different sampling rates and ranges to be used for each axis. To ensure that all geometric features are expressed, the designer ensures that the Nyquist-Shannon sampling theorem holds for the selected spatial sampling rate in all three dimensions. This means selecting a sampling rate whose frequency is at least twice that of the highest frequency component among all of the geometry and material nodes in tree structure 160. When periodic functions are used to define material distributions or geometry, the minimum sample frequency, Fₘᵢₙ, may be calculated using:

$${F}_{min} = min ( \frac{2}{{P}_{0}} , … , \frac{2}{{P}_{i}} ) \qquad ( 4 )$$

where Pᵢ is the period of the i-th function in tree structure 160.

### Affine Invariance

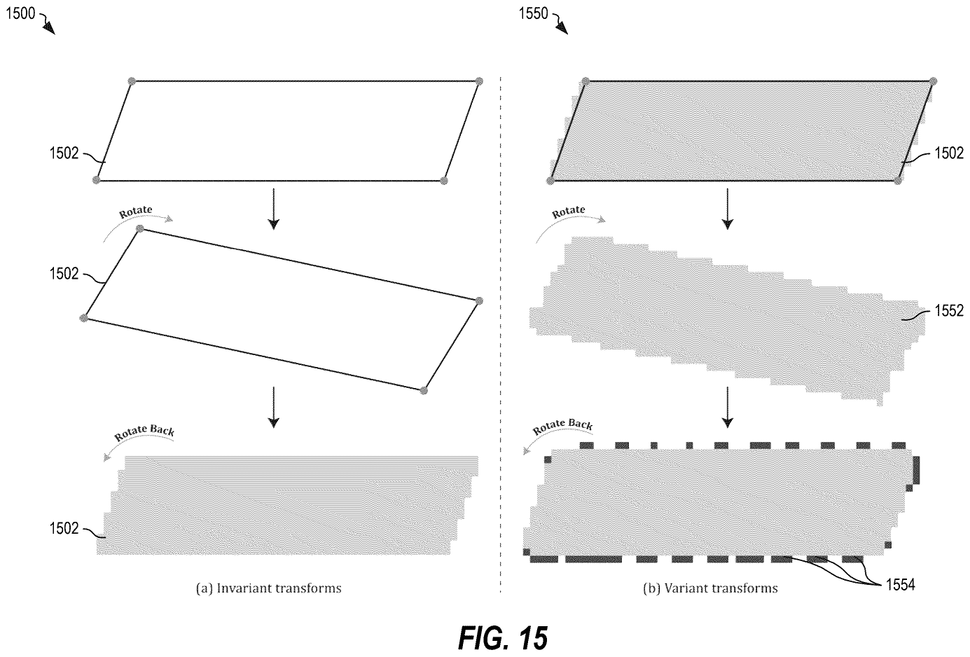

One of the major disadvantages of sampled representations like voxels is that they are not affine-transformed accurately. Unlike b-reps, voxelized objects are not affine-invariant. FIG. 15 is a schematic illustrating use of affine invariant representations 1500 and non-affine-invariant representations 1550 while rotations are applied to an object 1502. In affine invariant representations 1500, rotations are performed on the points before sampling to maintain affine-invariance. However, non-affine-invariant representations 1550 are sampled before rotations are applied, shown rotated as object 1552, leading to error (shown as pixels 1554) when object 1552 is rotated back to the original orientation. As demonstrated by FIG. 15, transforming discrete sampled objects may lead to decreased model accuracy. Accordingly, affine variance presents a major roadblock for designers wishing to create engineering-grade objects using discrete volumetric information. Multi-material volumetric modeling system 100 avoids these issues by leveraging tree structure 160. Because objects are represented implicitly as nodes in tree structure 160, a designer may apply all affine transformations before multi-material volumetric object 110 is sampled. Affine transformations are accomplished by propagating parent transformations down to children as tree structure 160 is evaluated.

### Performance Analysis

The following benchmarking and analysis demonstrates that the methods proposed here yield multi-material volumetric modeling system 100 as a feasible tool for real-world volumetric design. These results demonstrate the performance of an initial version of multi-material volumetric modeling system 100, which omits potential anticipated optimizations. First, the algorithmic complexity of evaluating each node type of multi-material volumetric modeling system 100 is analyzed. Then, a run-time analysis for slicing single nodes is presented. Finally, the effect of tree complexity on slice time is assessed.

TABLE 2
Time complexity of evaluating individual nodes in OpenVCAD. For
leaf nodes, an individual node refers to a tree with only that
node in it. For operator nodes, convolve( ) and f-grade( ), the
sphere( ) node is used as the only child, forming a two-node tree.

| | Time | |
|---|---|---|
| Node | Complexity | Where |
| Sphere | O(1) | — |
| Cube | O(1) | — |
| Mesh | O(1) | — |
| Convolve | O(kₓ × k_{y} × k_{z}) | (kₓ × k_{y} × k_{z}) is the size of the kernel |
| F-grade | O(n) | n is the number of tokens in the largest |
| | | equation |

The time complexity of evaluating a single location in R³ for each node in the script language of multi-material volumetric modeling system 100 is given in Table 2. CSG primitives, such as the sphere( ) and cube( ) nodes, are evaluated against pre-compiled code that runs in O(1) time. Similarly the mesh( ) node is pre-processed into a sparse grid that is evaluated in O(1) time. The time complexity of the f rep( ) and f grade( ) nodes are driven by their reliance on Dijkstra's Shunting Yard Algorithm to parse mathematical string expressions. The Shunting Yard algorithm runs in O(n) where n is the number of tokens in the equation. Even though the complexity for functional nodes is not constant, the complexity of evaluating each location is independent of the model and grid size, which is critical for keeping run times tractable. In most use cases, the number of tokens in the f rep( ) and f grade( ) equations is small and near constant. Similarly, the performance of convolve( ) nodes is dependent on the kernel size, which in practice is typically small enough to produce near constant time behavior. This relationship is illustrated by the timing results of Table 3.

TABLE 3
Benchmarking results for individual nodes in OpenVCAD.

| | Evaluation | Slicing | Voxels per |
|---|---|---|---|
| Node | Time (s) | Time (s) | second |
| Sphere | 35 | 248 | 3.7 × 10⁷ |
| Cube | 44 | 241 | 3.6 × 10⁷ |
| Mesh | 163 | 251 | 2.5 × 10⁷ |
| F-Rep | 584 | 248 | 1.2 × 10⁷ |
| Convolve | 62 | 250 | 3.3 × 10⁷ |
| F-Grade | 1147 | 223 | 7.5 × 10⁶ |

Each test was completed with a grid size of [2¹¹, 2¹¹, 2¹²] resulting in 2¹¹×2¹¹×2¹² [symbol] 1.7×10¹⁰ voxels. Evaluation time is the number of seconds taken to compile the multi-material design into a volumetric format. Slicing time is the number of seconds required to save this volumetric data to stacked PNG files. For a single layer, the slicing time refers only to the time required to encode that layer's matrix of color values into the PNG format and save to disk. The slicing time reported in the table refers to the sum of this time for all layers saved to disk.

Multi-material volumetric modeling system 100 supports multithreading, therefore the timing benchmarking tests were conducted using an AMD Ryzen 7 7700X 8-core processor with 16 threads. In these tests, individual nodes are sampled across a large grid and the evaluation and slicing times were recorded. Evaluation time refers to the time required to evaluate the tree and determine the material for each voxel. Slicing time refers to the time needed to output the voxel information as a PNG file. The workload was distributed in a way that allowed each thread to individually sample and export a distinct layer of the object. The data reported below are the wall-clock times taken by the multithreaded evaluation. The results of benchmarking tests show that the slicing time remains constant across node types. As indicated by the algorithmic complexities, the evaluation time was higher for nodes that express materials compared to nodes that only express geometry. The throughput of each test is expressed as the voxels sampled per second. This metric indicates the total geometric bandwidth OpenVCAD can compile per unit time. The evaluation time is of particular interest because this operation is fundamental to all volumetric exporters. The slicing time is dependent on the volumetric exporter used and can vary depending on disk quality and format used. These results show that evaluation of all nodes in OpenVCAD perform within an order of magnitude. Additionally, we investigated how the complexity of the tree impacts the compile time of an object. This assessment uses the same CPU configuration that was used for Table 3.

TABLE 4
Benchmarking results various real-world objects shown in FIG. 13

| | | | Evalu- | | |
|---|---|---|---|---|---|
| | | | ation | Slicing | Voxels |
| | Object Size | | Time | Time | per |
| Example | (mm) | Voxels | (s) | (s) | second |
| OpenVCAD | 140 × 7 × 28 | 2.8 × 10⁸ | 21 | 7 | 1.0 × 10⁷ |
| Text^{a} | | | | | |
| Screwdriver | 22 × 144 × 22 | 6.7 × 10⁸ | 97 | 15 | 5.9 × 10⁶ |
| Soft | 48 × 48 × 75 | 1.8 × 10⁹ | 251 | 41 | 6.3 × 10⁶ |
| Actuator^{c} | | | | | |

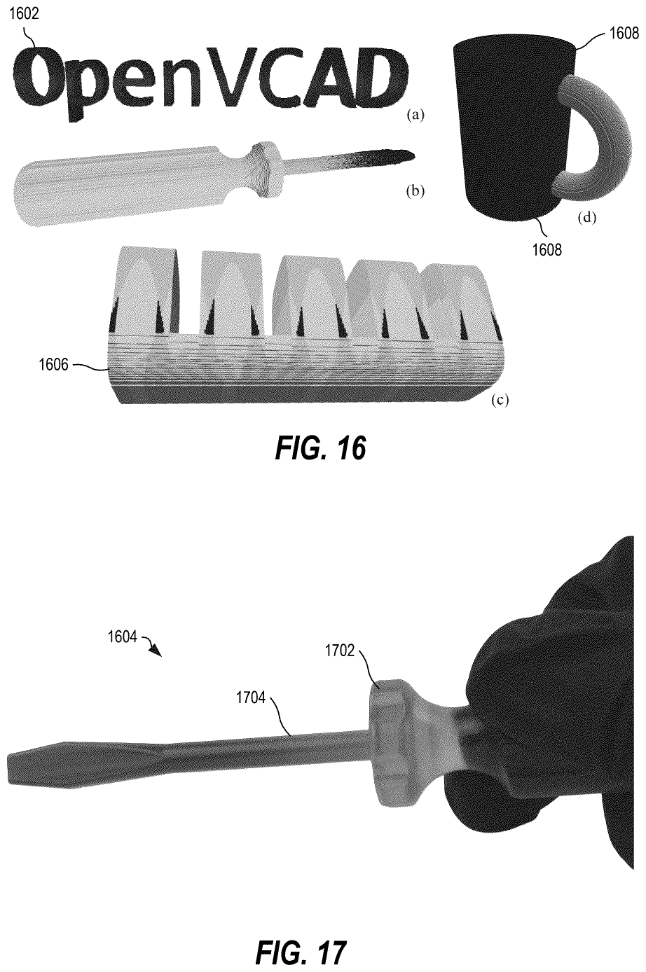

FIG. 16 shows renders of four composite objects 1602, 1604, 1606, and 1608 chosen to demonstrate multiple tree structure 160 configurations and real world use cases of multi-material volumetric modeling system 100 of FIGS. 1 and 3, in embodiments. These objects are varied in physical size and type of nodes used. Object 1602 is a mesh node is graded with two materials. Object 1604 is a screwdriver that is comprised of a mesh node and graded with three materials. Object 1606 is a soft actuator defined by a functional geometry node and graded with three materials. Object 1608 is a mug that is designed using multiple functional geometry nodes and Boolean operations. The results of evaluating and slicing these four objects using multi-material volumetric modeling system 100 are recorded in Table 4. As listed in Table 4, the largest and most complex object took approximately 16 minutes to be sampled into printable files. In contrast, smaller and simpler objects were converted in under five minutes. As in the previous benchmarking test, the voxel outputs per second were within an order of magnitude for all objects tested. This finding indicates that although the time taken to evaluate an object is dependent on the complexity of tree structure 160, the processing time is dominated by the size of the objects being expressed.

FIG. 17 shows screwdriver object 1604 of FIG. 16 in further example detail. Screwdriver object 1604 is constructed using a Stratasys J750 Polyjet printer that uses multiple materials for producing a soft-touch handle 1702 and a multi-color shaft 1704.

### Case Studies

The following case studies were conducted using multi-material volumetric modeling system 100 to demonstrate its efficacy as a multi-material additive manufacturing workflow. Both test cases were chosen to highlight tree structure 160 that uses different forms of geometry, material usage, and compositing. Likewise, both case studies highlight the capability of multi-material volumetric modeling system 100 to design meta-materials and compliant mechanisms.

### Functionally Graded Wing

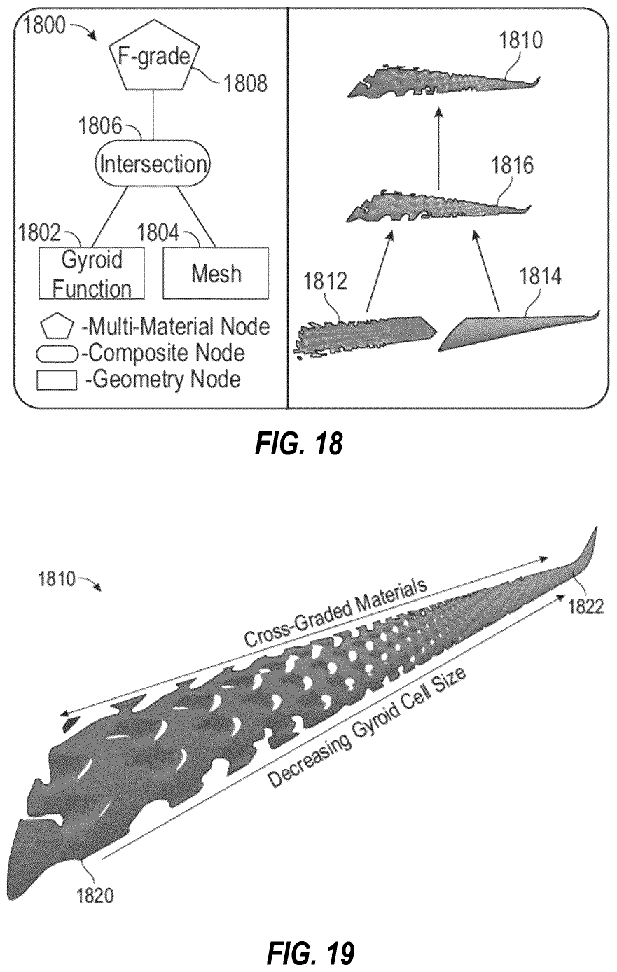

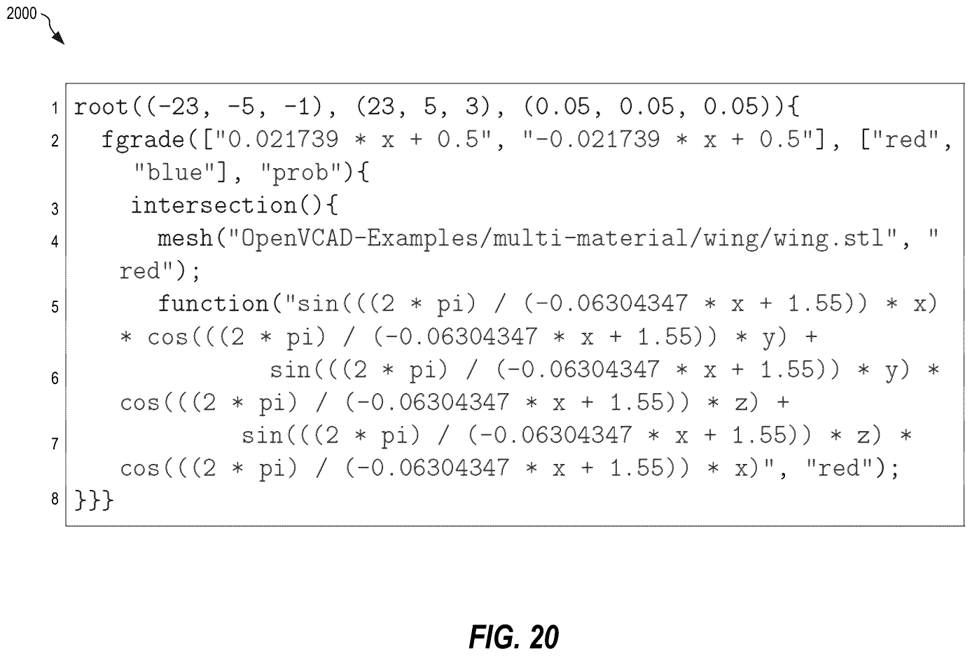

FIG. 18 shows one example tree structure 1800 that generates a triply periodic gyroid infill pattern for a wing 1810, in embodiments. FIG. 19 shows wing 1810 of FIG. 18 in further example detail, in embodiments. FIG. 20 shows one example script 2000 that is parsed by multi-material volumetric design compiler 150 to form tree structure 1800 that is used to generate wing 1810 of FIGS. 18 and 19, in embodiments. FIGS. 18, 19 and 20 are best viewed together with the following description. Tree structure 1800 is an example of tree structure 160 of FIG. 1 and includes an f rep( ) node 1802 to generate a gyroidal surface 1812, a mesh( ) node 1804 to generate a wing geometry 1814, and an intersection( ) node 1806 that combines gyroidal surface 1812 with wing geometry 1814 to generate infill object 1816. Finaly, an f grade( ) node 1808 is used to process infill object 1816 to cross-grade two materials together along the length of wing 1810. A quality of wing 1810 is enhanced by decreasing the cell size of the gyroid pattern along the length of wing 1810, since this preserves geometric detail in thinner sections of the wing. Similarly, a heavier, stiffer material 1820 gives way to a lighter, more flexible material 1822 along the direction of the wing.

A functional geometry node of multi-material volumetric modeling system 100 is well suited to express triply periodic geometry like the gyroid pattern of gyroidal surface 1812 of FIG. 18. Equation 5 expresses a gyroidal surface as a function ōf (X,Y,Z). Using the f rep( ) type node of multi-material volumetric modeling system 100, f rep( ) node 1802 of tree structure 1800 implements equation 5 to generate a uniform gyroidal pattern as gyroidal surface 1812 that is then bound with a mesh surface of wing geometry 1814 to form infill object 1816 as shown in FIG. 18. Adding a functional grading node to the network creates a cross-grade of two materials to form a meta-material. The material distribution could be modified using functional grading to optimize for multiple factors such as stiffness, durability, or thermal conductivity depending on the location on the wing.

Similarly, FIG. 18 shows the gyroidal infill being further parameterized by varying the unit cell length, α, across the length of the wing. The model was oriented such that the longest dimension of the wing was aligned with the x-axis. A parameter of α=−0.063x+1.55 was used to linearly decrease the unit cell size. This method could be used in conjunction with simulated stress distribution as known in the art. Of note, wing 1810 of FIGS. 18 and 19 takes only 8 lines of script, as shown in FIG. 20.

$$sin ( \frac{2 π}{a} x ) cos ( \frac{2 π}{a} y ) + sin ( \frac{2 π}{a} y ) cos ( \frac{2 π}{a} z ) + sin ( \frac{2 π}{a} z ) cos ( \frac{2 π}{a} x ) = h \qquad ( 5 )$$

### Multi-Material Organic Lattices

A key application of functional grading is with lattice structures. Lattices leverage the geometric freedom provided by additive manufacturing to construct objects that yield better mechanical performance compared to objects with a homogeneous composition. Multi-material design adds another dimension by which lattice structures might improve designs.

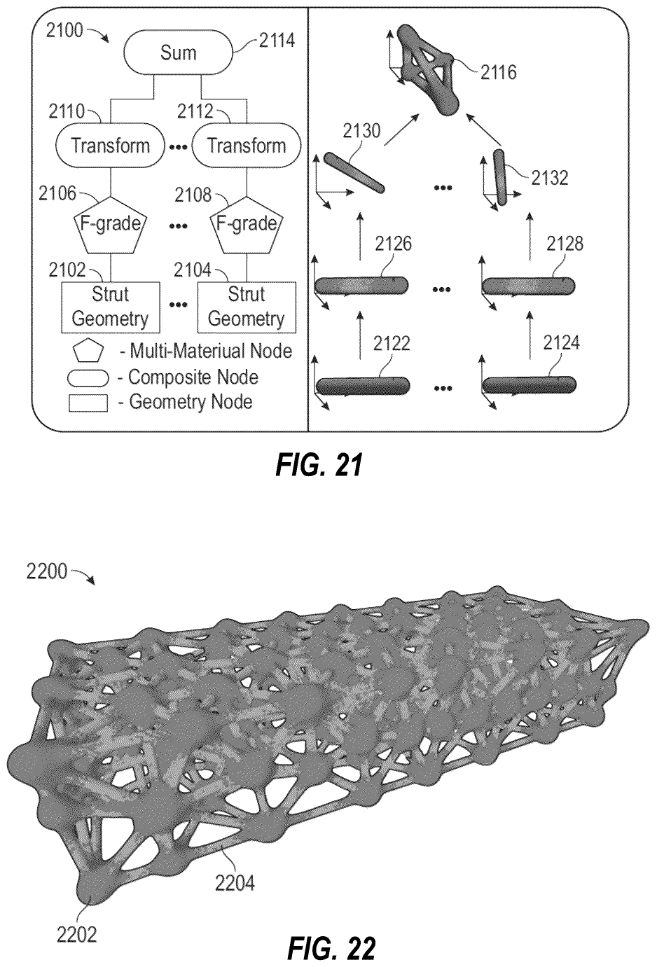

FIG. 21 shows one example tree structure 2100 that generates a tetrahedron lattice unit cell 2116 with graded members, in embodiments. FIG. 22 shows a larger lattice structure in the form of a composite tetrahedron 2200. FIGS. 21 and 22 are best viewed together with the following description. For clarity of illustration, FIG. 21 shows generation of only two of the six struts of tetrahedron lattice unit cell 2116.

Multi-material volumetric design compiler 150 generates tree structure 2100 from a script 140 as described above. Tree structure 2100 includes multiple strut( ) geometric primitive nodes 2102, 2104 that define cylindrical struts 2122, 2124 of a given length. F-grade nodes 2106, 2108 apply a functional grading to each individual cylindrical strut 2122, 2124 to yield members 2126, 2128 that (a) resist compression in the center, and (b) bonds well with adjacent members at the ends. Transformation nodes 2110, 2112 transform (e.g., rotate, translate, and scale) members 2126, 2128 to fit the designed dimension of tetrahedron lattice unit cell 2116 as shown by members 2130, 2132, respectively. Tree structure 2100 includes a sum( ) node 2114 that combines the six struts into a single object, tetrahedron lattice unit cell 2116. Sum( ) node 2114 is similar to the union( ) node in that it combines multiple children into a single object, however it differs in how it combines the child geometry. Sum( ) node 2114 treats a child geometry node as a scalar field of distances from the surface of the strut. When sampled in R³ the scalar values are summed and a level set is taken through it. This, combined with a blending constant, cause the joints of the tetrahedron to organically morph together similar to how metaballs behave.

Adding members to the lattice is as simple as computing another point in the 3D triangulation and repeating the steps to define, grade, transform and sum them with existing struts. The strut geometry for composite tetrahedron 2200 is generated by first performing a 3D tetrahedral meshing of a rectangular prism. For each edge in the tetrahedral mesh, a strut is generated and two overlapping normal distributions are applied to functionally grade materials together along the length of the strut. A sum( ) node is used to combine all of the struts into a single composite object. This example expands on the mechanical motivation of FIG. 21 by highlighting a composite lattice structure with mechanical properties that are optimized by functional grading. For example, a designer could tweak the concentration of an energy absorptive material graded into the center of the strut. Similarly, architecting the concentration of stiff materials in certain struts could yield a compliant mechanism that deforms more under load in certain areas of the design. Component geometry is defined as individual unit struts along the x-axis. The struts are then functionally graded to form a meta-material where a first material 2202 has better adhesion between connected strut endpoints and a second material 2204 at a center of the struts exhibits better compression resistance when compared with first material 2202 at the ends. The struts are transformed and combined via a summing operation to yield composite tetrahedron 2200.

### Bottlenecks and Areas for Improvements

Although multi-material volumetric modeling system 100 performs well with the example objects in FIG. 16, processing time is highly dependent on the object size and printer resolution. As such, the following potential improvements may overcome identified bottlenecks in the current implementation.

One limitation in the current implementation of multi-material volumetric modeling system 100 is the inability to prune or simplify design trees containing redundant expressions. An example of redundant design at the cost of performance would be expressing periodic geometry, such as in the soft actuator object 1606 of FIG. 16, with multiple discrete nodes for each period defined in Cartesian space. Instead, this same geometry should be expressed over multiple periods with a parameterized equation using cylindrical coordinates. Similar to how traditional programming language compilers, like GCC, optimize the code before generating machine instructions, multi-material volumetric design compiler 150 would benefit from analogous methods to optimize tree structure 160.

Furthermore, performance of multi-material volumetric modeling system 100 could be improved by reducing the number of locations sampled to determine the value of each voxel. This is possible when there are large regions in an object that do not vary in geometry or material, which is common in real-world applications. Multi-material volumetric modeling system 100 may be enhanced to use interval arithmetic to partition space to simplify an object's geometry and/or used to rapidly evaluate closed-form implicit surfaces by skipping regions that do not have varying geometry. Such interval arithmetic methods couple be applied to both the geometric and material compositions of an object to reduce the sampling space and improve performance of multi-material volumetric modeling system 100.

Multi-material volumetric modeling system 100 may also benefit from GPU acceleration to improve object compilation speed by compiling closed-form implicit surfaces into an intermediate language that is interpreted using massively parallel rendering on GPUs to reduce object rendering and sampling times.

Multi-material volumetric modeling system 100 allows for full control of material distribution throughout an object. This puts designers in control of where and what materials compose a region. However, it is currently up to designers to ensure that material combinations are printable. This may lead to a situation where an invalid material combination results in a failed print, leaving the designer to find a ‘needle in a haystack’ to fix the error. Multi-material volumetric modeling system 100 may be enhanced with a design validation mechanism that ensures that unprintable regions are identified and corrected automatically during the design process.

### Applications of OpenVCAD to Non-Inkjet Systems

Multi-material volumetric modeling system 100 currently targets multi-material AM devices 180 such as inkjet that support design import via stacked image files, although it also supports export of boundary surface representations compatible with virtually all AM systems. Multi-material volumetric modeling system 100 may be enhanced to target additional systems such as fused filament fabrication, directed energy deposition, and powder bed fusion. One potential avenue for the application of multi-material volumetric modeling system 100 to fused filament fabrication is using multiple hot ends with appropriate halftoning, or mixing extruders. Recent work has shown that it is possible to mix multiple filaments in melt chamber of hot ends to create gradients. Similarly, researchers have employed an analogous strategy by using multiple wire feeders to create material mixtures in the melt pool of a directed energy deposition system. The mixing ratios of the independent extruders or wire feeders could be defined by multi-material volumetric modeling system 100 and sampled across tool-paths to define gradients. For laser powder bed fusion systems, varying laser power yield objects with different mechanical properties. Accordingly, future extensions of multi-material volumetric modeling system 100 may involve grading laser power to yield objects with similar mechanical properties to those printed with multiple materials, even with just one powder.

### CONCLUSION

In this paper, we have presented a novel volumetric design method for multi-material additive manufacturing. The language of scripts 140 and multi-material volumetric design compiler 150 creates a compact and portable representation of dense volumetric designs. The proposed set of functional nodes establishes a robust framework for applied research into volumetric 3D printing. Functional geometry nodes allow designers to express complex and parametric shapes that retain their accuracy when transformed and combined to form composite designs. Functional grading and convolution nodes allow research into lattice structures and meta-materials that can vary material composition throughout geometric regions. The flexibility of tree structure 160 and multi-material volumetric design compiler 150 enables designs that have high geometric and material complexity, a dichotomy that has plagued previous methods. Further exploration of “digital materials” and pseudo-alloys is made possible with the extensible modeling language and multi-material volumetric design compiler 150.

### Related Work

Multi-material volumetric modeling system 100 builds on the foundations of both single-material homogeneous design and multi-material heterogeneous design to provide a framework for multi-material AM. Multi-material volumetric modeling system 100 is designed to be a cohesive 3D-printing workflow that fully leverages recent advancements in multi-material hardware and applications. In this section, critical advancements in additive manufacturing hardware are discussed. These advancements have created a greater need for multi-material design tools and make multi-material volumetric modeling system 100 both timely and necessary.

### Multi-Material Additive Manufacturing Technology

The widespread adoption of 3D printing (3DP) necessitates a paradigm shift in the way engineers design objects. Without constraints of traditional subtractive fabrication, AM enables greater flexibility in the geometry of engineered objects. Consequently, there has been extensive development of deposition modalities and their expansion to multiple materials. Common deposition modalities that allow multiple materials include fused filament fabrication vat photopolymerization or stereolithography, direct ink write, inkjet, binder jetting, and powder bed fusion. Multi-material machines have seen improvement in two technologies: printers with multiple simultaneous deposition points, and diverse build materials with unique properties (e.g., flexibility, conductivity, strength, etc.). The ability to interleave multiple materials has extended 3DP toward the production of full-color objects, parts with graded material properties. Researchers have also used multi-material 3DP to simulate biological tissue and create low-cost, open source prosthetics. The primary innovations in multi-material AM techniques have been with fused filament fabrication, stereolithography, and inkjetting.

Fused filament fabrication (FFF) has seen many innovations with multi-material 3DP in the form of multiple extrusion points and filament multiplexers. Both innovations allows for the alternating deposition of different materials within the same layer of a print. There are many commercially available two-channel FFF printers on the market. Many of these machines use a single printer head with two material channels. On each layer, the channels take turns depositing material in particular regions of the print. Recent advancements have created systems that extend this method by using multiple discrete print heads that are interchanged to add greater numbers of material channels. Similarly, multiplexing systems like Prusa Research's MMU3 allow for the material in a single deposition channel printer to be automatically changed during a print. However, these setups are limited to a small number of material types, typically less than six, and the overhead involved in switching material or print heads within a layer can dramatically increase print time.

Similar to FFF, stereolithography (SLA) has seen advancements in its capability to produce multi-material designs. With the development of multi-vat printers, there has been recent work in the functional grading of parts. This method has fabricated robots with piezoelectric actuation and multi-material hydrogels as well as electromagnetic devices having materials with differing dielectric constants.

Material-jetted 3D printing, also known by its commercial trade names Polyjet or MultiJet Modeling, uses inkjet technology to deposit micro-scale droplets of material. By using multiple fluid channels, it also offers rapid transitions between materials during a print and higher combined throughput and precision compared to other AM approaches, typically providing a large (>30 l) build volume with feature sizes below 150 μm. Inkjetting offers the unique capability of enabling materials with widely varying properties to form composites with visual and mechanical gradients, active parts including semiconductors and electrical circuits, and functional “print-in-place” objects requiring no additional assembly. The following discussion focuses on inkjet printing because of its superior deposition control. However, a section below details applications to other AM practices.

### Applications of Multi-Material Additive Manufacturing

Multi-material AM methods suggest a path toward integrated manufacturing of entire systems in which the precise material distribution determines the functionality. Recent work in “material intelligence” has attempted to imbue macroscopic materials with functional properties. For example, multi-material AM techniques were employed to produce lattice-based, meta-material objects that exploit both geometry and material distribution to achieve extreme performance. In another example, the critical stress and strain in a soft material could be independently adjusted by controlling the material distribution. Further, the complete functional mechanism of a door latch was realized by creating specific architected sub-domains within an overall structure. The same authors showed a variety of other compliant structures, for which they created a custom design-automation editor specific to the compliant structures that were the focus of the study. More broadly, the application of two or more material components characterized by continuous gradual changes in material distribution is known as functionally graded materials (FGMs). Advancements in AM hardware have made it possible to fabricate FGMs with ease, leading to FGMs becoming a driving force behind the development of multi-material heterogeneous design methods. As such, a heterogeneous design method for AM should include features that enable the easy and efficient expression of FGMs.

Besides fabricating FGMs, another major benefit of AM is the simplification of assemblies. Emergent methods for multi-material fabrication have facilitated hybrid electronics, i.e., the co-printing of structural material alongside electrically conductive structures. There has been development in printable strain sensors for monitoring structural health by printing with both non-toxic and conductive polylactic acid filaments. In their survey paper on 3D-printed electronics, Persad et al. stated that “there is still room for the development and integration of software tools for the design and modeling of antennae and sensor structures which are intended to be manufactured using these 3DP technologies”. As such, a robust heterogeneous AM design method should interface with simulation software.

Another emerging area of multi-material AM fabrication is printed robotics. Recent work in multi-material inkjet fabrication has shown that co-printing solids and liquids is possible. This allows for complex fluidic designs that other methods of manufacturing either cannot produce or would require onerous steps to assemble. This previous work demonstrated the complete fabrication of a hexapod robot, fully-automating the production in a single multi-material printing step. Additionally, there has been further work detailing the liquid-solid fabrication method and providing examples of other structures that could be fabricated in this manner. Heterogeneous design is necessary to facilitate the expression of both solid and liquid regions in these fabricated objects. Related work in liquid and solid co-printing on inkjet systems has shown that viscoelastic behavior can be tailored by intermixing fluid and polymer during the printing process. MacCurdy and Lipton presented a method to architect impact and vibration absorbing meta-materials for integration into robots using an algorithmic approach. Their work demonstrated that material concentration can be engineered to yield architected viscoelastic behavior. Lipton expanded on this work by employing liquid and solid co-printing to embed fluid regions in impact absorbing closed-cell foams. These applications rely on fitting numerical models using mechanical testing and characterization to establish a relationship between material concentrations and mechanical behavior. The characterization of these printed materials results in a mathematical expression that can be used by designers to control the mechanical behavior of their part. As such, a heterogeneous design method should allow designers to express material concentrations as spatially parametric expressions.

Medical image printing and pre-surgical planning models are another area of particular interest for heterogeneous multi-material design. Recent work has shown that medical images can be processed for and printed on inkjet systems. These works include printing both visually and mechanically realistic pre-surgical planning models. Jacobson presented a workflow for performing bitmap-based printing of pre-surgical planning models using voxels. However, one key problem that remains is creating realistic tissue analogs. Related works have shown that meta-materials can be architected with desired material properties on inkjet systems. Similar work by Doubrovski et al. has shown that medical images can be used to design multi-material heterogeneous prosthetic objects. As such, a robust heterogeneous design method should support medical scan data as input and provide image processing utilities such as thresholding and convolution to support the processing of raw data into realistic pre-surgical planning models. Furthermore, the processing of medical images benefits from the ability to interface scan data geometry and materials with engineered objects, such as prosthetics, to yield custom-fit orthotics.

### Homogeneous Multi-Material Design

By far the most common prior-art method of multi-material design is homogeneous solid-body modeling. In this process, multi-material objects are expressed as multiple discrete solid bodies which are each assigned a material channel before printing. This multi-material AM work reflects the underlying geometric representation employed by modern CAD software such as SolidWorks and Fusion360. These CAD programs use a mixture of CSG and b-reps to visualize and create solid bodies. A b-rep is a solid whose surface has been subdivided into a collection of cells made up of vertices, edges, and faces. Further, it is a collection of orientable surfaces bounded and connected without self-intersection to form an object that conveys topological information. Similarly, traditional CSG defines a solid only by its surface. A GPU-accelerated CSG slicer called IceSL was proposed by Lefebvre et al. that can do multi-material homogeneous design. CSG was created to visualize 3D objects and intended to be used with ray tracing to determine where external surfaces should be displayed on screen. Thus, CSG and b-rep approaches are limited in the expression of heterogeneous material distributions. As an example, when using b-rep, each model may consist of only a single material that is solid throughout the entirety of the bounded surface. Practically, this dictates that for every independent volume and material type, there must be a separate boundary. When representing the continuous material distributions that are common in FGMs, sampling and thresholding is necessary to separate the continuous material into discrete assignable regions. As the number of threshold regions increases, so does the number of required b-reps and corresponding computational cost of toolpath planning. Additionally, this threshold approach creates sharp material transition zones that can lead to structural weaknesses. While solid body modeling has historically been sufficient for subtractive manufacturing processing, surface representations lack the volumetric information required for emerging multi-material AM methods.

Functional Geometry Representations—One common problem faced in CAD is the compactness of expressing complex geometry. Likewise, many CAD programs for AM rely on verbose and approximate geometry representations like triangulated meshes. These b-rep files have two primary disadvantages: file size and approximation. B-reps typically also require interactive design software to define objects. This has inhibited b-rep adoption in simulation and optimization workflows because manual design iteration is required by the user after each step. Pasko et al. proposed an alternative to b-rep called functional representation (f-rep). F-reps are composed of functions of the form ƒ(x)≥0. The surface of an object is the set of points {x} such that ƒ(x)=0. A point in space that evaluates to a negative number is outside the object while a point that evaluates to a positive number is inside the object. The function ƒ(x) may be viewed as a “black box” and may contain math expressions or parametric code. However, ƒ(x) must have parameters for spatial sampling. Furthermore, f-rep objects can be combined using union, intersection, and subtraction operations. Since all operations in f-reps may be defined analytically, they are particularly well suited for applications that require a high degree of programmatic parameterization, such as optimization. F-reps have also been effective in modeling volumetric lattice structures. Additionally, f-reps have been extended to not only represent geometry but also to describe volumetric features of an objects such as opacity or material distribution.

### Heterogeneous Multi-Material Design

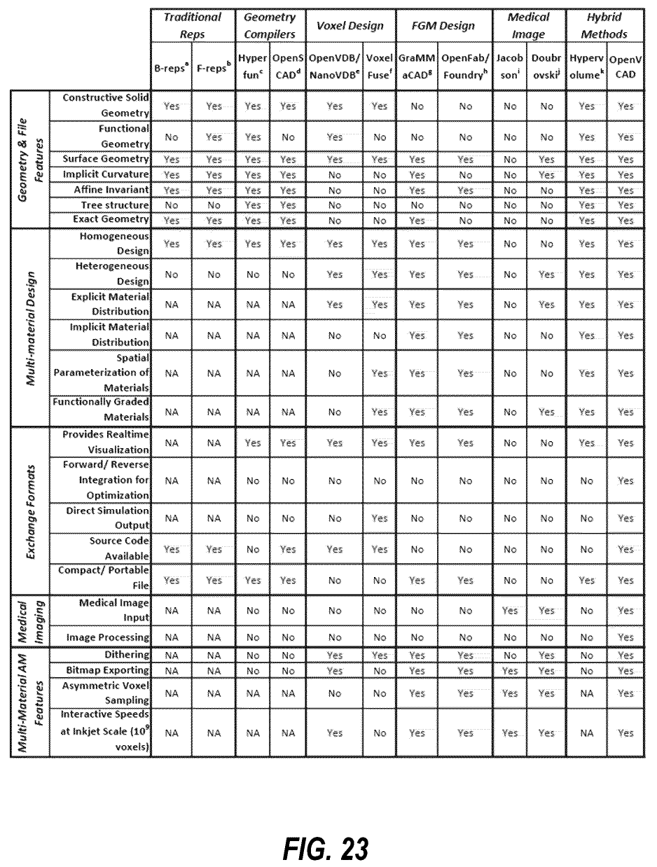

Heterogeneous design methods may be classified into two broad categories: those directly applicable to AM and those which are more broadly intended for computer graphics and rendering. A heterogeneous design method is classified as being applicable to AM if it directly addresses its application to the slicing and preparation of print files for a multi-material AM process. FIG. 23 shows a table that synthesizes the current state of heterogeneous design methods and highlights the shortcomings that are addressed by multi-material volumetric modeling system 100 of FIG. 1.

### Heterogeneous Design for Graphics and Rendering

Heterogeneous design is a common problem faced by the graphics and rendering community. Common applications of heterogeneous design involve the expression and rendering of volumetric data such as medical images, water, clouds, and fire. This data is routinely expressed as 3D voxel grids that store information on material concentrations, opacity and density. Two of the most common methods for rendering voxel data are texture slicing and ray-tracing. Texture slicing involves sampling the heterogeneous design at regular intervals into texture memory on a graphics processing unit (GPU) using data-slice polygons. By rending the slices from farthest to nearest, a translucent object can be rendered. Similarly, ray-tracing can be done by first sampling a heterogeneous design into voxels. Rays are then cast from a camera though the voxel-grid to yield a render of the design. Both of these methods rely on heterogeneous designs stored as voxels grids, requiring O(n³) space complexity. The voxel size of modern inkjet systems, such as the Stratasys J750, yields build volumes with four billion voxels, presenting a computational barrier for using traditional voxel design tools with modern AM.

Museth proposed OpenVDB, a sparse-voxel data structure that may improve the memory footprint. OpenVDB provides a suite of design tools for manipulating voxel design, such as Boolean operations and affine transforms. Museth improved on the CPU-only limitation in OpenVDB by providing a GPU-native sparse-voxel data structure with NanoVDB. However, this massively parallel version does not include many of the design tools that were provided with the original OpenVDB library. Although OpenVDB and NanoVDB can provide an efficient representation for heterogeneous models that contain large sparse regions, designs that contain random material distributions, as is common with stochastic sampling used in inkjet printing, diminish the efficacy of the sparse data structure.

A key limitation of voxel data structures is their discrete sampled nature. Similar to how f-rep geometry has a smaller storage footprint compared to the same geometry sampled as a triangulated mesh, functional representation for materials is more efficient than voxels. Pasko et al. proposed a method that uses n user-defined scalar fields coupled with a geometric primitive to represent geometry and other attributes such as density or opacity of an object called Constructive Hypervolume Modeling. Using Pasko's method, a designer may combine and modify multiple objects, each with its own multidimensional attribute sets, using operators in a tree. In this structure, object primitives are in the leaves and operations in the nodes. Ambiguities in how min/max operations were applied to heterogeneous material distribution attributes in Pasko's original work were later solved by Fayolle and Pasko using signed approximate real distance functions. Pasko's method uses a special constructive tree similar in structure to a BlobTree. Pasko's constructive tree is a hierarchical structure where implicit surfaces are leaves and operations (blending, warping, and Booleans) are nodes. When attributes are defined in non-leaf nodes of a constructive tree, values override attributes lower down the hierarchy. Constructive hypervolume modeling is a theoretical framework that was applied to heterogeneous texturing of rendered models and lacks the necessary methods for multi-material design for AM systems. One key feature that is missing is a method to sample the continuous f-reps that define material distributions into discrete voxel print formats such a bitmap stacks. Additionally, constructive hypervolume modeling defines attributes as a high level concept. Although this definition allows for attributes to represent many different features, such as opacity, density and temperature, their focus on abstraction lacks a method to ensure a valid volume fraction is defined everywhere in R³ when modeling material distributions.

### Heterogeneous Design Methods for AM

Multi-material volumetric modeling system 100 builds on insights from several existing heterogeneous design methods specifically targeted at AM. VoxelFuse is a tool for design and fabrication of functionally graded materials and solid bodies, and incorporates Brauer and Aukes's voxel-based CAD framework. The framework allows for modeling with multiple materials by storing CSG-constructed solid bodies and material concentrations as voxels. Voxels allow for the simultaneous definition of shape and material. Additionally, the voxel-based framework allows users to define keep-out, clearance, web, and support regions that simplify design processes specific to the intended method of manufacturing. Furthermore, VoxelFuse incorporates a voxelization engine and simulation capabilities. The voxelization engine can convert mesh files into voxel representation and allows for the mixed use of VoxelFuse with other common CAD tools that produce mesh files, such as OpenSCAD, SolidWorks, and Fusion360. The included simulation capabilities are based on the VoxCAD and Voxelyze frameworks. While VoxelFuse offers a variety of features for designing printed FGMs, its primary drawback is its reliance on a voxel-backed data structure. Similar to the space and time complexity problems that plague OpenVDB and NanoVDB, VoxelFuse does not scale to modern inkjet volumes. In these tools, operations are O(n³) with the number of voxels. This limits the size and complexity of objects that can be designed with VoxelFuse.

Foundry and OpenFab are design tools that enable multi-material volumetric design. OpenFab focuses on using multiple materials of varying color for rapid manufacturing and has been applied to both robotics and aesthetic design. OpenFab uses a two stage approach starting with a boundary-surface phase as input, followed by a volume-definition phase. In both phases, textures and “fgablets” are applied to render a graphic across the constructed geometry. Shapes are created by using a scene graph describing a set of object b-reps that is then tessellated and eventually voxelized before being dithered and exported as a final output. Foundry boasts a more polished user interface, but also focuses on texture rendering and synthesis. The premise of Foundry is to modify the material composition of existing geometries. This tool allows the user to create alloyed or functionally graded materials, but requires the user to generate the geometry using a separate tool.

A related tool, GraMMaCAD, allows a user to import an existing boundary-surface definition and interactively define material gradients in various regions of the part. While intuitive to use, interactive tools that import existing solid-body geometry become tedious to use when many sub-regions of the part need to be independently identified and addressed by the user. These complex geometric features are common in many applications including soft robotics, functional meta-materials, and hybrid electronics. Instead, design tools that natively operate on volumes, and which allow programmatic design via scripting, are necessary to allow the creation of complex multi-material objects.

Elber et al. explore the evolution of geometric modeling tools, emphasizing the shift from Non-Uniform Rational B-splines (NURBs) to a B-spline based volumetric representation (V-rep). Their paper discusses how V-reps can support the creation of porous, heterogeneous, and anisotropic objects. They argue that V-reps allow for a tighter integration between multi-material design and finite element analysis, facilitating the manufacturing of functionally graded materials and geometries.

### Current Challenges for Heterogeneous AM Design

In their review paper, Fayolle et al. stated: “Currently, two extreme cases are common in the research literature; it is either an object with simple geometry (e.g., cube or cylinder) with a complex material distribution or a complex object with simple material composition. However, the ultimate goal in this research direction is to provide methods and tools of defining complex, shape conforming material distributions for objects with complex geometry.” Achieving both geometric and material complexity has been an ongoing challenge in the heterogeneous design space. Volumetric objects can be space inefficient, hard to express, and incompatible with existing AM workflows. FIG. 1 shows a summary of the existing homogeneous and heterogeneous design methods and the features they support. These features include items identified by Fayolle et al. as critical for enabling simultaneous complexity of object geometry and material distribution. Additionally, FIG. 1 includes relevant features such as geometry types supported, medical imaging utilities, and methods that enable direct application to multi-material AM systems. To the inventors' knowledge, OpenVCAD is the only available method that can address this range of needs.

Several methods depicted in FIG. 23 illustrate a lineage of development in 3D CAD. For instance, Hypervolume is developed upon Hyperfun, which in turn is based on f-reps. FIG. 23 highlights the historical progression of these methods, showcasing the progress in CAD, while pointing out that no single tool implements the suite of capabilities that are currently necessary.

Additionally, this approach provides a contextual framework for understanding related developments that diverged from these intermediate methodologies. For example, OpenSCAD extends upon Hyperfun's foundation but does not incorporate the heterogeneous design functionalities featured in the Hypervolume extension. Similarly, by comparing geometric representations like b-reps and f-reps with software tools, different implementations selectively incorporate elements from each representation. This is relevant because one of the goals of the present embodiments, and for multi-material volumetric modeling system 100, is to integrate and extend ideas from the past 40 years of 3D CAD that are useful to users of modern volumetric multi-material 3D printers.

### Geometry Compilers

Multi-material volumetric modeling system 100 is a multi-material geometry compiler. Therefore, it is necessary to discuss related work on geometry compilers. Boundary representations use primitive geometry types such as points, lines and curves combined with basic CSG-like operations to form objects. Similarly, volumetric design routinely employs a single primitive, the voxel, to express geometry. These geometry representations are usually created using interactive CAD software. Parametric features are enforced by the CAD system and can only be modified using a graphical user interface, limiting the complexity of highly parametric objects. To address these concerns, attempts have been made to define geometry and heterogeneous material distributions using a compiled approach. In the geometry compiler paradigm, the designer expresses an object using a specific programming language. Various keywords, functions, variables, and loops are used to define the object's geometry and attributes. The text is passed to a compiler that converts it into another desired format such as a triangulated mesh or render.

One of the earliest geometry compilers was proposed and released as an open source project by Pasko. Known as Hyperfun, this tool used f-reps in conjunction with a special programming language to define highly parametric objects. Hyperfun provided several different geometric operations like union, difference, intersection, as well as math function like sqrt, exp, log, and sin. An extension of Hyperfun into heterogeneous design was done by Pasko in “Constructive hypervolume modeling” and later expanded by Fayolle. Hyperfun was also extended to support functional micro-structure design and 3D printing.

Similarly, OpenSCAD is a programming-oriented, parametric design tool for creating solid bodies from boundary surface representations. Users define geometry by writing a script with OpenSCAD's program-specific language. OpenSCAD serves as the compiler that processes the scripts as CSG trees and renders the 3D object. CSG trees represent Boolean combinations of primitive shapes (e.g. cubes, spheres, and cylinders) to describe more complex geometries. While OpenSCAD is a robust and accessible tool for 3D modeling, it retains the limitations of the underlying boundary surface representations. To represent objects with multi-materials using OpenSCAD, the designer must export each discrete material region as a single body; designs with regions of multi-material graded or densely interdigitated material distributions at realistic resolutions require unreasonable file sizes and compile times. This constraint hinders OpenSCAD's adoption in multi-material 3D printing workflows.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

### Combinations of Features

Features described above as well as those claimed below may be combined in various ways without departing from the scope hereof. The following examples illustrate possible, non-limiting combinations of features and embodiments described above. It should be clear that other changes and modifications may be made to the present embodiments without departing from the spirit and scope of this invention:

(A1) A method for multi-material volumetric modeling includes processing a tree structure that represents an object having multiple materials. The tree structure includes one or more leaf nodes, each leaf node of the one or more leaf nodes representing a geometric primitive. The tree structure also includes one or more composite nodes, each composite node of the one or more composite nodes indicating (i) a transformation of one sub-object connected to said each composite node or (ii) a combination of two sub-objects connected to said each composite node. The tree structure also includes one or more multi-material nodes, each multi-material node of the one or more multi-material nodes indicating how each of at least two of the multiple materials is distributed over a volume of a sub-object connected to said each multi-material node.

(A2) In the method denoted (A1), at least one of the one or more multi-material nodes includes a functional grading node that defines a probability distribution of each of the multiple materials over the volume of the sub-object.

(A3) In either of the methods denoted (A1) and (A2), at least one of the one or more multi-material nodes includes a convolution node that indicates a convolution-based distribution of each of the multiple materials over the volume of the sub-object.

(A4) In any of the methods denoted (A1) to (A3), at least one of the one or more leaf nodes includes a constructive solid geometry primitive, an implicit geometric primitive, or a voxel grid.

(A5) In any of the methods denoted (A1) to (A4), each of the one or more leaf nodes identifies one of the multiple materials.

(A6) In any of the methods denoted (A1) to (A5), said processing further includes generating a multi-material volumetric representation of the object.

(A7) In the method denoted (A6), the method further includes outputting the multi-material volumetric representation.

(A8) In the method denoted (A7), said outputting includes sending the multi-material volumetric representation to a multi-material additive manufacturing device.

(A9) In the method denoted (A8), the method further includes forming the object with the multi-material additive manufacturing device and based on the multi-material volumetric representation.

(A10) In either of the methods denoted (A8) and (A9), said outputting includes sending the multi-material volumetric representation to an external computing system.

(A11) In any of the methods denoted (A6) to (A10), the multi-material volumetric representation includes a plurality of voxels. Said processing further includes using the tree structure to determine one of the multiple materials, or lack of material, for each of the plurality of voxels.

(A12) In the method denoted (A11), the plurality of voxels lie within a three-dimensional space.

(A13) In the method denoted (A12), each of the plurality of voxels is asymmetric.

(A14) In the method denoted (A12), each of the plurality of voxels is symmetric.

(A15) In any of the methods denoted (A1) to (A14), the method further includes constructing the tree structure.

(A16) In the method denoted (A15), said constructing includes parsing a script.

(B1) A system for multi-material volumetric modeling includes a processor and a memory in communication with the processor. The memory stores a tree structure that represents an object having multiple materials. The tree structure includes one or more leaf nodes, each of the one or more leaf nodes representing a geometric primitive. The tree structure also includes one or more composite nodes, each composite node of the one or more composite nodes indicating (i) a transformation of one sub-object connected to said each composite node or (ii) a combination of two sub-objects connected to said each composite node. The tree structure also includes one or more multi-material nodes, each multi-material node of the one or more multi-material nodes indicating how each of at least two of the multiple materials is distributed over a volume of a sub-object connected to said each multi-material node. The system also includes a graphics engine implemented as machine-readable instructions that are stored in the memory and, when executed by the processor, control the system to process the tree structure.

(B2) In the system denoted (B1), at least one of the one or more multi-material nodes includes a functional grading node that defines a probability distribution of each of the multiple materials over the volume of the sub-object.

(B3) In either of the systems denoted (B1) and (B2), at least one of the one or more multi-material nodes includes a convolution node that indicates a convolution-based distribution of each of the multiple materials over the volume of the sub-object.

(B4) In any of the systems denoted (B1) to (B3), at least one of the one or more leaf nodes includes a constructive solid geometry primitive, an implicit geometric primitive, or a voxel grid.

(B5) In any of the systems denoted (B1) to (B4), each of the one or more leaf nodes identifies one of the multiple materials.

(B6) In any of the systems denoted (B1) to (B5), the memory stores additional machine-readable instructions that, when executed by the processor, control the system to generate a multi-volumetric representation of the object.

(B7) In the system denoted (B6), the memory stores additional machine-readable instructions that, when executed by the processor, control the system to output the multi-volumetric representation of the object.

(B8) In the system denoted (B7), the machine-readable instructions that, when executed by the processor, control the system to output the multi-volumetric representation of the object include machine-readable instructions that, when executed by the processor, control the system to send the multi-material volumetric representation to a multi-material additive manufacturing device.

(B9) In the system denoted (B8), the system further includes the multi-material additive manufacturing device.

(B10) In either of the systems denoted (B8) and (B9), the machine-readable instructions that, when executed by the processor, control the system to output the multi-volumetric representation of the object include machine-readable instructions that, when executed by the processor, control the system to send the multi-material volumetric representation to an external computing system.

(B11) In any of the systems denoted (B6) to (B10), the multi-material volumetric representation includes a plurality of voxels. Said processing further includes using the tree structure to determine one of the multiple materials, or lack of material, for each of the plurality of voxels.

(B12) In the system denoted (B11), the plurality of voxels lie within a three-dimensional space.

(B13) In the system denoted (B12), each of the plurality of voxels is asymmetric.

(B14) In the system denoted (B12), each of the plurality of voxels is symmetric.

(B15) In any of the systems denoted (B1) to (B14), the machine-readable instructions that, when executed by the processor, control the system to process the tree structure include machine-readable instructions that, when executed by the processor, control the system to parse a script.

What is claimed is:

1. A method for multi-material volumetric modeling, comprising:
processing a tree structure that represents an object having multiple materials, the tree structure comprising:
one or more leaf nodes, each leaf node of the one or more leaf nodes representing a geometric primitive;
one or more composite nodes, each composite node of the one or more composite nodes indicating (i) a transformation of one sub-object connected to said each composite node or (ii) a combination of two sub-objects connected to said each composite node; and
one or more multi-material nodes, each multi-material node of the one or more multi-material nodes indicating how each of at least two of the multiple materials is distributed over a volume of a sub-object connected to said each multi-material node.

2. The method of claim 1, at least one of the one or more multi-material nodes comprising a functional grading node that defines a probability distribution of each of the multiple materials over the volume of the sub-object.

3. The method of claim 1, at least one of the one or more multi-material nodes comprising a convolution node that indicates a convolution-based distribution of each of the multiple materials over the volume of the sub-object.

4. The method of claim 1, at least one of the one or more leaf nodes comprising a constructive solid geometry primitive, an implicit geometric primitive, or a voxel grid.

5. The method of claim 1, each of the one or more leaf nodes identifying one of the multiple materials.

6. The method of claim 1, wherein said processing further comprises generating a multi-material volumetric representation of the object.

7. The method of claim 6, further comprising outputting the multi-material volumetric representation.

8. The method of claim 7, wherein said outputting comprises sending the multi-material volumetric representation to a multi-material additive manufacturing device.

9. The method of claim 8, further comprising forming the object with the multi-material additive manufacturing device and based on the multi-material volumetric representation.

10. The method of claim 7, wherein said outputting comprises sending the multi-material volumetric representation to an external computing system.

11. The method of claim 6, wherein:
the multi-material volumetric representation includes a plurality of voxels; and
said processing further comprises using the tree structure to determine one of the multiple materials, or lack of material, for each of the plurality of voxels.

12. The method of claim 11, the plurality of voxels lying within a three-dimensional space.

13. The method of claim 12, each of the plurality of voxels being asymmetric.

14. The method of claim 12, each of the plurality of voxels being symmetric.

15. The method of claim 1, further comprising constructing the tree structure.

16. The method of claim 14, wherein said constructing comprises parsing a script.

17. A system for multi-material volumetric modeling, comprising:
a processor;
a memory in communication with the processor, the memory storing a tree structure that represents an object comprising multiple materials, the tree structure comprising:
one or more leaf nodes, each of the one or more leaf nodes representing a geometric primitive;
one or more composite nodes, each composite node of the one or more composite nodes indicating (i) a transformation of one sub-object connected to said each composite node or (ii) a combination of two sub-objects connected to said each composite node; and
one or more multi-material nodes, each multi-material node of the one or more multi-material nodes indicating how each of at least two of the multiple materials is distributed over a volume of a sub-object connected to said each multi-material node; and
a graphics engine implemented as machine-readable instructions that are stored in the memory and, when executed by the processor, control the system to process the tree structure.

18. The system of claim 17, at least one of the one or more multi-material nodes comprising a functional grading node that defines a probability distribution of each of the multiple materials over the volume of the sub-object.

19. The system of claim 17, at least one of the one or more multi-material nodes comprising a convolution node that indicates a convolution-based distribution of each of the multiple materials over the volume of the sub-object.

20. The system of claim 17, at least one of the one or more leaf nodes comprising a constructive solid geometry primitive, an implicit geometric primitive, or a voxel grid.

21. The system of claim 17, each of the one or more leaf nodes identifying one of the multiple materials.

22. The system of claim 17, the memory storing additional machine-readable instructions that, when executed by the processor, control the system to generate a multi-volumetric representation of the object.

23. The system of claim 22, the memory storing additional machine-readable instructions that, when executed by the processor, control the system to output the multi-volumetric representation of the object.

24. The system of claim 23, wherein the machine-readable instructions that, when executed by the processor, control the system to output the multi-volumetric representation of the object include machine-readable instructions that, when executed by the processor, control the system to send the multi-material volumetric representation to a multi-material additive manufacturing device.

25. The system of claim 24, further comprising the multi-material additive manufacturing device.

26. The system of claim 23, wherein the machine-readable instructions that, when executed by the processor, control the system to output the multi-volumetric representation of the object include machine-readable instructions that, when executed by the processor, control the system to send the multi-material volumetric representation to an external computing system.

27. The system of claim 22, wherein:
the multi-material volumetric representation includes a plurality of voxels; and
said processing further comprises using the tree structure to determine one of the multiple materials, or lack of material, for each of the plurality of voxels.

28. The system of claim 27, the plurality of voxels lying within a three-dimensional space.

29. The system of claim 28, each of the plurality of voxels being asymmetric.

30. The system of claim 28, each of the plurality of voxels being symmetric.

31. The system of claim 17, the memory storing additional machine-readable instructions that, when executed by the processor, control the system to process the tree structure.

32. The system of claim 31, wherein the machine-readable instructions that, when executed by the processor, control the system to process the tree structure include machine-readable instructions that, when executed by the processor, control the system to parse a script.

33. A method for multi-material volumetric modeling, comprising:
generating a geometric primitive for each of one or more geometry nodes of a tree structure representing an object having multiple materials;
performing, for each composite node of one or more composite nodes of the tree structure, (i) a transformation of one sub-object connected to said each composite node or (ii) a combination of two sub-objects connected to said each composite node; and
modifying, for each multi-material node of one or more multi-material nodes of the tree structure, a material composition of a sub-object connected to said each multi-material node.
